(19) United States
(12) Patent Application Publication
(10) Pub. No.: US 2005/0064289 A1
(43) Pub. Date: Mar. 24, 2005

(54) Electrode, electrochemical device, method for manufacturing electrode, and method for manufacturing electrochemical device

(75) Inventors: Tadashi Suzuki, Tokyo (JP); Masato Kurihara, Tokyo (JP); Satoshi Maruyama, Tokyo (JP)

Correspondence Address: OLIFF & BERRIDGE, PLC, P.O. BOX 19928, ALEXANDRIA, VA, 22320, US

(73) Assignee: TDK CORPORATION, Tokyo (JP)

(21) Appl. No.: 10/876,636

(22) Filed: Jun. 28, 2004

(30) Foreign Application Priority Data
Aug. 29, 2003 (JP) P2003-307733
Jul. 3, 2003 (JP) P2003-270720
Dec. 25, 2003 (JP) P2003-430838

(51) Int. Cl. H01M 4/62; H01M 4/04

(52) U.S. Cl. 429/209; 429/232; 429/217; 252/182.1

(57) ABSTRACT

The electrode of the present invention is provided with an active material-containing layer comprising as the structural material composite particles composed of an electrode active material, a conductive additive and a binder, and a current collector in electrical contact with the layer. The composite particles are formed by integrating the conductive additive and binder with the electrode active material particles. The active material-containing layer is formed by subjecting powder comprising at least the composite particles to pressurization treatment to form a sheet, and placing the sheet at the location of the current collector at which the active material-containing layer is to be formed. The electrode active material and conductive additive in the active material-containing layer are non-isolated and electrically linked. This construction allows an electrode with excellent electrical characteristics to be realized, which exhibits adequately reduced internal resistance and easily permits increased energy density to be achieved for electrochemical devices.

### BACKGROUND OF THE INVENTION

1. Field of the Invention

The present invention relates to an electrode which can be used as an electrochemical device for a primary battery, secondary battery (especially a lithium ion secondary battery) electrolytic cell, capacitor (especially an electrochemical capacitor) or the like, and to an electrochemical device employing it. The invention further relates to a method for manufacturing the electrode and to a method for manufacturing an electrochemical device provided with the electrode.

2. Related Art

Development of portable devices has been dramatic in recent years, driven largely by development of high-energy batteries such as lithium ion secondary batteries which are widely used as power sources for such devices. Such high-energy batteries are, generally, composed mainly of a cathode, an anode, and an electrolyte layer situated between the cathode and anode (for example, a layer comprising a liquid electrolyte or solid electrolyte).

Also, high-energy batteries including lithium ion secondary batteries, and electrochemical devices such as electric double layer capacitors have been researched and developed with the aim of further improving properties to allow future development of various devices, such as portable devices, which require electrochemical devices. It is especially desired to realize electrochemical devices with high energy density.

Cathodes and/or anodes have conventionally been manufactured through steps of preparing coating solutions (for example, in slurry or paste form) for electrode formation comprising the respective electrode active materials, a binder (synthesis resin, etc.), a conductive additive and a dispersing medium and/or solvent, and coating the surface of a current collector member (for example, a metal foil) with each respective coating solution and drying it to form an electrode active material-containing layer (hereinafter referred to as “active material-containing layer”) on the surface of the current collector member (for example, see Japanese Patent Application Laid-open No. 11-283615).

In this process (known as “wet process”), the conductive additive is not added to the coating solution in some cases. Also, instead of a coating solution comprising a dispersing medium and solvent, there is sometimes prepared a kneaded mixture containing the electrode active material, a binder and a conductive additive, and the kneaded mixture is molded into a sheet using a hot roll machine and/or a hot press machine. In other cases, a “polymer electrode” is formed by further addition of a conductive polymer to the coating solution. When the electrolyte layer is a solid, the coating solution is often coated onto the surface of the electrolyte layer.

There has also been proposed, for example, a lithium secondary battery positive electrode and process for its manufacture, wherein composite particles composed of manganese dioxide (cathode active material) particles and carbon material powder (conductive additive) fixed on the surfaces of the manganese dioxide particles as the cathode material are used to prevent cathode attributable reduction in the charge-discharge capacity of the battery, in order to achieve further improved battery properties (for example, see Japanese Patent Application Laid-open No. 2-262243).

There has also been proposed a process for manufacturing an organic electrolyte battery positive electrode mixture, by preparing a slurry comprising a positive electrode active material (cathode active material), conductive agent (conductive additive), binder and aqueous solvent, having a solid content of 20-50 wt % and a solid mean particle size of no greater than 10 μm, and granulating the slurry by spray drying, in order to achieve greater improvement in properties such as discharge characteristics and productivity (for example, see Japanese Patent Application Laid-open No. 2000-40504).

### SUMMARY OF THE INVENTION

However, lithium ion secondary batteries provided with electrodes manufactured by wet methods, including the technique described in Japanese Unexamined Patent Publication HEI No. 11-283615 mentioned above, have been associated with the problems described below, which have limited battery energy density increase.

Specifically, when the object is to achieve greater improvement in battery energy density, the thickness of the electrode active material-containing layer can be increased to allow greater battery capacity and reduce the proportion of current collector and separator which does not contribute to the battery capacity, with respect to the total thickness, thereby allowing the aforementioned object to be achieved. However, since the internal resistance (impedance) of the active material-containing layer of the electrode increases in such cases, it is not possible to guarantee sufficient battery output. That is, batteries provided with conventional electrodes have been restricted from having thicker electrode active material-containing layers, due to increasing internal resistance. In particular, it has been very difficult to achieve adequately high energy densification in electrodes having active material-containing layer thicknesses of 100 μm or greater, because of the problem of high internal resistance.

The present inventors have also found that the composite particles described in Japanese Unexamined Patent Publication HEI No. 2-262243 have low mechanical strength and the carbon material powder fixed to the surface of the manganese dioxide particles tends to fall off during electrode formation and during charge-discharge, such that the dispersability of the carbon material powder in the resulting electrode tends to be insufficient, making it impossible to reliably and adequately achieve the expected improvement in electrode characteristics.

Also, the organic electrolyte battery positive electrode mixture described in Japanese Unexamined Patent Publication No. 2000-40504 is produced in the form of masses (composite particles) composed of the positive electrode substance, the conductive agent and the binder, by spray drying the solvent slurry in hot air. The present inventors found that, in this case, since the positive electrode active material, conductive agent and binder are dried and solidified while dispersed in the solvent, aggregation between the binder and aggregation of the conductive agent proceed during drying, and conductive agent and binder do not bind in an adequately dispersed state to the surfaces of the particles, made of the respective positive electrode active materials composing the resulting masses (composite particles), to allow maintenance of an effective conductive network.

More specifically, the present inventors found that according to the technique described in Japanese Unexamined Patent Publication No. 2000-40504 and shown in FIG. 20, there are numerous portions which are surrounded only by large aggregates P33 composed of the binder and are electrically isolated in the masses (composite particles) P100, among the particles made of the respective positive electrode active materials composing the masses (composite particles) P100. In addition, it was found that when the particles made of the conductive agent form aggregates during drying, the particles made of the conductive agent become maldistributed as aggregates P22 in the resulting masses (composite particles) P100, such that an electron conduction path (electron conduction network) cannot be adequately formed in the masses (composite particles) P100, and hence adequate electron conductivity cannot be achieved. Furthermore, it was found, the aggregates P22 of particles made of the conductive agent are also surrounded by only the large aggregates P33 made of the binder and are electrically isolated, and from this standpoint as well, an electron conduction path (electron conduction network) cannot be adequately formed in the masses (composite particles) P100, such that adequate electron conductivity cannot be achieved.

Similar problems are faced with primary batteries and secondary batteries other than the type of lithium ion secondary battery described above, which have electrodes produced by the ordinary manufacturing process (wet process) of the prior art described above, that is, the process using a coating solution comprising at least an electrode active material, a conductive additive and a binder.

The same problems have also been encountered with electrolytic cells having electrodes, as well as with capacitors (for example, electrochemical capacitors such as electric double layer capacitors) produced by a method using an electroconductive material (carbon material or metal oxide) as the electrode active material instead of the electrode active material of the battery, and using a slurry containing at least this material, a conductive additive and a binder.

It is an object of the present invention, which has been accomplished in light of the prior art described above, to provide an electrode having sufficiently reduced internal resistance and excellent electrode characteristics which allow the energy density of the electrochemical device to be increased even when the active material-containing layer thickness is 100 μm or greater, as well as an electrochemical device provided with the electrode and having sufficient energy density. The invention further provides a manufacturing method which allows the aforementioned electrode and electrochemical device to be produced in an easy and reliable manner.

As a result of much diligent research directed toward achieving the aforestated object, the present inventors discovered that since the conventional electrode-forming process involves a method wherein a coating solution or kneaded mixture comprising at least the aforementioned electrode active material, conductive additive and binder is used for the electrode formation, the non-uniform dispersed state of the electrode active material, conductive additive and binder in the active material-containing layer of the electrode has a major effect leading to the problems referred to above.

Specifically, in the process using a coating solution or kneaded mixture, such as the technique described in Japanese Unexamined Patent Publication HEI No. 11-283615, the coating solution or kneaded mixture is coated onto the surface of the current collector to form a coated film of the coating solution or kneaded mixture on the surface, and the coated film is dried to remove the solvent and form an active material-containing layer. The present inventors found that the conductive additive and binder, which have lighter specific gravities, are lifted nearer to the surface of the coated film during the course of drying of the coated film. As a result, it was discovered, the dispersed state of the electrode active material, conductive additive and binder in the coated film cannot form an effective conductive network, and therefore the dispersed state becomes non-uniform and it becomes impossible to achieve adequate cohesion between the three components, i.e. the electrode active material, conductive additive and binder, formation of a satisfactory electron conduction path in the resulting active material-containing layer is also prevented, and reduction in the specific resistance and charge transfer overpotential of the active material-containing layer is prohibited.

Moreover, it was also discovered that in the process of granulation by spray drying of a conventional slurry, such as for the composite particles described in Japanese Unexamined Patent Publication No. 2000-40504, since the positive electrode active material (cathode active material), conductive agent (conductive additive) and binder are included in the same slurry, the state of the electrode active material, conductive additive and binder in the obtained granules (composite particles) depends on the dispersed state of the electrode active material, conductive additive and binder in the slurry (especially the dispersed state of the electrode active material, conductive additive and binder during the course of drying of the slurry droplets), and therefore aggregation and maldistribution of the binder and aggregation and maldistribution of the conductive additive occurs, as explained above with reference to FIG. 20, creating a condition wherein the dispersed state of the electrode active material, conductive additive and binder in the obtained granules (composite particles) cannot form an effective conductive network, and for example, the dispersed state becomes non-uniform making it impossible to achieve adequate cohesion between the three components, i.e. the electrode active material, conductive additive and binder, and preventing formation of a satisfactory electron conduction path in the resulting active material-containing layer.

The present inventors additionally found that in such cases, the conductive additive and binder contact with the electrolyte solution and cannot selectively and satisfactorily disperse on the surface of the electrode active material which is able to contribute to the electrode reaction, while excess conductive additive is present which is not involved in formation of the electron conduction network that allows efficient conduction of electrons generated at the reaction sites, and excess binder is also present which merely increases the electrical resistance.

The present inventors found, also, that in the conventional techniques which include the composite particles described in Japanese Unexamined Patent Publication HEI No. 2-262243 and Japanese Unexamined Patent Publication No. 2000-40504, the dispersed state of the electrode active material, conductive additive and binder in the coated film becomes non-uniform, and therefore sufficient cohesion cannot be achieved between the electrode active material and conductive additive and the current collector. In particular, the problem whereby the dispersed state of the coating and of the electrode active material, conductive additive and binder in the electrode obtained from it becomes non-uniform, and the components thus become maldistributed in the electrode, is notable when the thickness of the active material-containing layer increases.

Although it is commonly recognized among those skilled in the art that the internal resistance of an electrode tends to increase when a binder is used, the present inventors made the discovery explained below which led to the present invention. That is, the present inventors discovered that if particles comprising an electrode active material, conductive additive and binder are formed by the following granulating step, and are used as a structural material for formation of an electrode active material-containing layer by a dry method, it is possible to construct an active material-containing layer with a sufficiently lower specific resistance than the electrode active material itself despite inclusion of a binder, and this discovery led to completion of the present invention.

More specifically, the invention provides an electrode

having at least a conductive active material-containing layer comprising, as the structural material, composite particles composed of an electrode active material, a conductive additive with an electron conductive property, and a binder capable of binding the electrode active material and the conductive additive, and a current collector situated in electrical contact with the active material-containing layer,

wherein the composite particles are formed by a granulating step in which the conductive additive and binder are bonded to and integrated with particles made of the electrode active material,

the active material-containing layer is formed by a dry sheet-forming step wherein the powder comprising at least the composite particles obtained by the granulating step is subjected to pressurization treatment to form a sheet in order to obtain a sheet containing at least the composite particles, and an active material-containing layer placement step wherein the sheet is placed as an active material-containing layer at a position on the current collector where the active material-containing layer is to be formed,

and the electrode active material and conductive additive are non-isolated and electrically linked in the active material-containing layer.

The electrode of the invention allows the specific resistance and charge transfer overpotential of the active material-containing layer to be adequately reduced compared to electrodes of the prior art, and therefore the electrochemical device energy density can be easily and reliably increased even if the active material-containing layer thickness is 100 μm or greater.

According to the invention, the “electrode active material” which serves as the structural material of the composite materials is a substance such as described below, depending on the electrode to be formed. Specifically, when the electrode to be formed is an electrode for use as a primary battery anode, the “electrode active material” is a reducing agent, and when it is for use as a primary battery cathode, the “electrode active material” is an oxidizing agent. Also, the “particles made of the electrode active material” may also include substances other than the electrode active material so long as the function of the invention (the function of the electrode active material) is not hindered.

When the electrode to be formed is an anode for use in a secondary battery (during discharge), the “electrode active material” is a reducing agent, and it is a substance which can exist in a chemically stable state in either its reduced form or oxidized form and which can reversibly undergo reduction reaction from the oxidized form to the reduced form and oxidation reaction from the reduced form to the oxidized form. When the electrode to be formed is a cathode for use in a secondary battery (during discharge), the “electrode active material” is an oxidizing agent, and it is a substance which can exist in a chemically stable state in either its reduced form or oxidized form and which can reversibly undergo reduction reaction from the oxidized form to the reduced form and oxidation reaction from the reduced form to the oxidized form.

In addition to the cases mentioned above, when the electrode to be formed is an electrode for use in a primary battery and secondary battery, the “electrode active material” may be a material capable of intercalation and deintercalation (occlusion and release, or doping and dedoping) of the metal ions which contribute to the electrode reaction. As examples of such materials there may be mentioned carbon materials, metal oxides (including compound metal oxides) and the like used in lithium ion secondary battery anodes and/or cathodes.

For convenience throughout the present specification, the electrode active material of the anode will be referred to as “anode active material”, and the cathode electrode active material of the cathode will be referred to as “cathode active material”. The “anode” of the “anode active material” in this case is a negative electrode active material, based on the polarity during discharge of the battery, while the “cathode” of the “cathode active material” is a positive electrode active material, based on the polarity during discharge of the battery. A specific example of the anode active material and cathode active material will be explained below.

In the case wherein the electrode to be formed is an electrode to be used in an electrolytic cell, or an electrode to be used in a capacitor (condenser), the “electrode active material” is a metal (including metal alloys), metal oxide or carbon material having an electron conductive property.

The composite particles used in the electrode of the invention are particles wherein the conductive additive, electrode active material and binder are bonded together with each in a very satisfactory dispersed state. The composite particles are used as the major component of the powder for production of the active material-containing layer of the electrode by the dry process described hereunder.

A very satisfactory three-dimensional electron conduction path (electron conduction network) is formed in the interior of the composite particles. When they are used as the major component of the powder for production of the active material-containing layer of the electrode by the dry process described hereunder, the structure of the electron conduction path can maintain its approximate original state even after formation of the active material-containing layer by heat treatment and pressurization treatment.

In other words, the electrode of the invention is formed while maintaining the structure of the composite particles, and therefore the electrode active material and conductive additive are non-isolated and electrically linked in the active material-containing layer. Consequently, a very satisfactory three-dimensional electron conduction path (electron conduction network) is formed in the interior of the composite particles. In particular, a very satisfactory three-dimensional electron conduction path (electron conduction network) is formed in the interior of the composite particles even if the active material-containing layer thickness is 100 μm or greater.

Here, the statement that “the electrode active material and conductive additive are non-isolated and electrically linked in the active material-containing layer” means that the particles (or aggregates) made of the electrode active material and the particles (or aggregates) made of the conductive additive are “substantially” non-isolated and electrically linked in the active material-containing layer. More specifically, it does not mean that all of the particles (or aggregates) made of the electrode active material and the particles (or aggregates) made of the conductive additive are completely non-isolated and electrically linked, but rather that they are sufficiently linked electrically to allow electrical resistance to be achieved of a level exhibiting the effect of the invention.

This condition wherein “the electrode active material and conductive additive are non-isolated and electrically linked in the active material-containing layer” may be confirmed by an SEM (Scanning Electron Microscope) photograph, TEM (transmittance Electron Microscope) photograph and EDX (Energy Dispersive X-ray Fluorescence Spectrometer) analysis data for a cross-section of the active material-containing layer of the electrode of the invention. The electrode of the invention can be clearly distinguished from a conventional electrode by comparing an SEM photograph, TEM photograph and EDX analysis data for a cross-section of the active material-containing layer with an SEM photograph, TEM photograph and EDX analysis data for the conventional electrode.

The active material-containing layer in the electrode of the invention is preferably obtained by further applying heat treatment during pressurization treatment in the dry sheet-forming step, from the standpoint of more reliably obtaining the aforementioned effect of the invention.

The composite particles used in the electrode of the invention are preferably formed by a granulating step which comprises

a stock solution preparation step wherein a stock solution containing a binder, conductive additive and solvent is prepared,

a fluidized bed forming step wherein the particles made of the electrode active material are introduced into a fluidizing tank to form a fluidized bed of the particles made of the electrode active material, and

a spray drying step wherein the stock solution is sprayed in the fluidized bed containing the particles made of the electrode active material to attach and dry the stock solution onto the particles made of the electrode active material, the solvent is removed from the stock solution attached to the surfaces of the particles made of the electrode active material, and the particles made of the electrode active material are bonded to the particles made of the conductive additive by the binder.

By applying this preferred granulating step, it is possible to more reliably form the composite particles described above, and thus more reliably achieve the effect of the invention. In this granulating step, since fine liquid droplets of the stock solution comprising the conductive additive and binder are directly sprayed onto the particles made of the electrode active material in the fluidizing tank, it is possible to adequately promote aggregation of the constituent particles of the composite particles and thus adequately prevent maldistribution of the constituent particles of the obtained composite particles, as compared to the conventional composite particle manufacturing process. In addition, the conductive additive and binder contact with the electrolyte solution, and selectively and satisfactorily disperse on the surface of the electrode active material which is able to contribute to the electrode reaction.

Consequently, the composite particles formed by the preferred granulating step described above are particles wherein the conductive additive, electrode active material and binder are bonded together in a very satisfactory dispersed state. Furthermore, by adjusting the temperature in the fluidizing tank, the spraying volume of the stock solution sprayed into the fluidizing tank, the introduction volume of the electrode active material introduced into the fluid flow (for example, an air stream) generated in the fluidizing tank, the speed of the fluidized bed, the type of flow (circulation) of the fluidized bed (fluid flow) (laminar flow, turbulent flow, etc.) and other parameters during the granulating step, it is possible to freely adjust the sizes and shapes of the composite particles of the invention.

Thus, since it is sufficient for the liquid droplets of the stock solution comprising the conductive additive, etc. to be directly sprayed onto the flowing particles in the preferred granulating step described above, the fluidizing method is not particularly restricted and there may be used, for example, a fluidizing tank which fluidizes the particles by a generated air stream, a fluidizing tank which produces a rotating flow of the particles using a stirrer, or a fluidizing tank which fluidizes the particles by vibration. However, the process for manufacturing the electrode composite particles is preferably carried out while generating an air stream in the fluidizing tank during the fluidizing bed forming step and introducing the particles made of the electrode active material into the air stream to form a fluidized bed of the particles made of the electrode active material, from the standpoint of obtaining uniform shapes and sizes of the resulting composite particles.

A very satisfactory three-dimensional electron conduction path (electron conduction network) is more reliably formed in the interior of the composite particles formed by the granulating step described above. In addition, when the particles are used as the main component of the powder for production of the electrode active material-containing layer by the dry process described hereunder, the structure of the electron conduction path can maintain its approximate original state even after formation of the active material-containing layer by pressurization treatment (preferably heat treatment and pressurization treatment).

Thus, by using the composite particles as the main component of the powder for production of the electrode active material-containing layer by the dry process described hereunder, it is possible to adequately prevent reduction in cohesion between the conductive additive, electrode active material and binder, as well as reduction in cohesion of the conductive additive and electrode active material for the current collector surface, which occur in the prior art.

As a result, the present inventors conjecture that a very satisfactory three-dimensional electron conduction path (electron conduction network) is formed in the electrode active material-containing layer of the invention compared to electrodes of the prior art, thereby allowing a dramatic reduction in the specific resistance and charge transfer overpotential of the active material-containing layer.

Furthermore, by using the composite particles which exhibit excellent electron conductivity even when the electrode active material-containing layer is relatively thick (for example, 100 μm or greater), it is possible to form an electrode with low internal resistance (impedance), and therefore an electrochemical device provided with the electrode is capable of fast and reproducible charge-discharge (or discharge alone if the electrochemical device is a primary battery), at a relatively higher current density than according to the prior art, allowing high energy densification to be easily achieved.

The “dry sheet-forming step” according to the invention is a step in which only the “powder comprising at least composite particles” is used instead of using any liquid such as a solvent or dispersing medium for dissolution or dispersion of the structural material of the active material-containing layer, as is used in the wet process described above, and it is subjected to pressurization treatment (preferably heat treatment and pressurization treatment) to form a sheet.

According to the invention, the powder used in the dry sheet-forming step is preferably a powder consisting solely of the composite particles. This will facilitate formation of an active material-containing layer having a very satisfactory three-dimensional electron conduction path (electron conduction network) formed in the internal structure of the composite particles, by a simple manufacturing process.

In addition, the powder comprising at least composite particles used in the dry sheet-forming step according to the invention may also contain a conductive additive and/or binder, so long as the amount is in a range which does not lead to increased internal resistance (impedance).

From the standpoint of more reliably achieving high energy densification of the electrochemical device, the thickness T of the active material-containing layer in the electrode of the invention preferably satisfies the condition represented by the following inequality (1).
100 μm≦T≦2000 μm (1)

If the value of T is less than 100 μm, when constructing an electrochemical device for a battery or the like, the proportion of the volume of the structural members which do not contribute to the capacity of the electrochemical device (the current collector, e.g. metal foil, the separator, the cladding, etc.) with respect to the total volume of the electrochemical device increases, thereby tending to prevent a higher energy density compared to a conventional electrochemical device.

On the other hand, if the value of T is greater than 2000 μm, when forming the composite particles in the granulating step, it will be necessary to use particles with large particle sizes as the particles forming the nuclei for granulation (for example, the active material particles). In this case, the composite particles formed using particles with large particle sizes will tend to have a greater ion diffusion overpotential due to the large-sized particles. Consequently, an electrode provided with an active material-containing layer formed from the composite particles will tend to have inadequate electrical capacity. As a result, it will generally not be possible to achieve sufficiently high energy density for an electrochemical device provided with the electrode.

From the standpoint of more reliably achieving high energy densification of the electrochemical device, the mean particle size d of the composite particles in the active material-containing layer in the electrode of the invention preferably satisfies the condition represented by the following inequality (2).
10 μm≦d≦2000 μm (2)

If the mean particle size d of the composite particles does not satisfy the condition represented by inequality (2), i.e., if d is less than 10 μm, the particles (electrode active material particles, etc.) forming the nuclei for production of the composite particles will be too small, tending to make it impossible to achieve an adequate composite state. When the granulation step described above is carried out using a fluidizing tank, the particles forming the nuclei in the fluidizing tank will tend to aggregate, making it difficult to form a stable fluidized bed.

If the mean particle size d of the composite particles is greater than 2000 μm, it will be necessary to use particles with large particle sizes as the particles forming the nuclei for production of the composite particles. In this case, the composite particles formed using particles with large particle sizes will tend to have a greater ion diffusion overpotential due to the large-sized particles. Consequently, an electrode provided with an active material-containing layer formed from the composite particles will tend to have inadequate electrical capacity. As a result, it will generally not be possible to achieve. sufficiently high energy density for an electrochemical device provided with the electrode.

In addition, from the standpoint of more reliably achieving high energy densification of the electrochemical device, the thickness T of the active material-containing layer and the mean particle size d of the composite particles in the electrode of the invention preferably satisfy the condition represented by the following inequality (3).
1/20≦T/d≦200 (3)

If the ratio of the thickness T of the active material-containing layer and the mean particle size d of the composite particles (T/d) is less than 1/20(=0.05), the pressure for rolling of the layer of the composite particles will be too high during formation of the active material-containing layer, and it will tend to be difficult to maintain a satisfactory electron conduction network in the composite particles as described above.

On the other hand, if T/d is greater than 200, this will increase the degree of stacking of multiple composite particles in the active material-containing layer in the direction normal to the surface of the current collector, thereby forming contact interfaces between the composite particles. Since the interface resistance (electrical resistance) between the composite particles is larger than the internal resistance inside the composite particles, it will not be possible to achieve adequate output characteristics.

Particularly from the standpoint of adequately reducing the electrical resistance of the contact interface between the composite particles in the active material-containing layer, the ratio of T/d is preferably 1/20 to 150 and more preferably 1/20 to 100.

Preferably, the content of the conductive additive in the active material-containing layer of the electrode of the invention is 0.5-6 wt % based on the total weight of the active material-containing layer, the content of the binder in the active material-containing layer is 0.5-6 wt % based on the total weight of the active material-containing layer, and

the thickness T of the active material-containing layer satisfies the condition represented by the following inequality (4).
120 μm≦T≦2000 μm (4)

If the contents of the conductive additive and binder in the active material-containing layer are each within the ranges specified above and the thickness T of the active material-containing layer is between 120 μm and 2000 μm, it is possible to eliminate the problem of conventional electrodes, which is increased internal resistance when the active material-containing layer thickness exceeds 120 μm, and thereby more easily and reliably achieve high energy densification of the electrochemical device.

If the content of the conductive additive in the active material-containing layer is less than 0.5 wt % the amount of conductive additive will be too small, making it impossible to form a suitable conductive network in the active material-containing layer, while if the content of the conductive additive is greater than 6 wt %, a greater amount of the conductive additive will not be contributing to the electrical capacity, making it difficult to achieve sufficient volume energy density.

On the other hand, if the content of the binder in the active material-containing layer is less than 0.5 wt %, the amount of binder will be too small, making it impossible to form an active material-containing layer which maintains the structure of the composite particles, while if the content of the binder is greater than 6 wt %, a greater amount of the binder will not be contributing to the electrical capacity, making it difficult to achieve sufficient volume energy density.

Also, if the thickness T of the active material-containing layer is less than 120 μm, when constructing an electrochemical device for a battery or the like, the proportion of the volume of the structural members which do not contribute to the capacity of the electrochemical device (the current collector, e.g. metal foil, the separator, the cladding, etc.) with respect to the total volume of the electrochemical device increases, thereby tending to prevent a higher energy density compared to a conventional electrochemical device.

On the other hand, if the value of T is greater than 2000 μm, when forming the composite particles in the granulating step, it will be necessary to use particles with large particle sizes as the particles forming the nuclei for granulation (for example, the active material particles). In this case, the composite particles formed using particles with large particle sizes will tend to have a greater ion diffusion overpotential due to the large-sized particles. Consequently, an electrode provided with an active material-containing layer formed from the composite particles will tend to have inadequate electrical capacity, and as a result, it will be difficult to achieve sufficiently high energy density for an electrochemical device provided with the electrode.

From the standpoint of forming a more satisfactory electron conduction path (electron conduction network) in the active material-containing layer, the content of the conductive additive is preferably 0.5-6.0 wt % and more preferably 1.0-6.0 wt %, as mentioned above, and the content of the binder is preferably 0.5-6.0 wt % and more preferably 1.0-6.0 wt %, as mentioned above.

The active material-containing layer in the electrode of the invention may also contain a conductive polymer. This will allow formation of a polymer electrode as described above. In this case, the conductive polymer may be a conductive polymer with ion conductivity, or it may be a conductive polymer with electron conductivity. A conductive polymer with ion conductivity and a conductive polymer with electron conductivity may also be used together as conductive polymers.

By using this construction according to the invention, it is possible to easily and reliably form an electrode having more excellent electron conductivity and ion conductivity than conventional electrodes. If the conductive polymer employs composite particles as the main component of the powder for production of the active material-containing layer of the electrode by the dry method described hereunder, the constituent components other than the composite particles can be added to the powder for their inclusion in the active material-containing layer. A conductive polymer may also be included in the active material-containing layer by addition of the conductive polymer as a constituent component other than the composite particles, during preparation of the electrode-forming coating solution or electrode-forming kneaded mixture.

According to the invention, the conductive polymer may be further added as a structural material during formation of the composite particles. That is, the composite particles of the invention may also contain a conductive polymer. In this case as well, the conductive polymer may be a conductive polymer with ion conductivity, or it may be a conductive polymer with electron conductivity, while a conductive polymer with ion conductivity and a conductive polymer with electron conductivity may also be used together as conductive polymers.

By thus constructing the active material-containing layer using composite particles containing a conductive polymer, it is possible to easily form a very satisfactory ion conduction path and/or electron conduction path in the active material-containing layer of the electrode. The conductive polymer may also be included in the composite particles by addition as a structural material during formation of the composite particles.

According to the invention, when it is possible to use a conductive polymer as a binder, which is one of the structural materials of the composite particles, the conductive polymer used may be one with ion conductivity. That is, the binder of the invention may consist of a conductive polymer. A binder with ion conductivity should contribute to formation of an ion conduction path in the active material-containing layer, while a binder with electron conductivity should contribute to formation of an electron conduction path in the active material-containing layer.

The conductive polymer may be added to either or both the structural material of the composite particles, and as a constituent component of the powder for electrode formation (dry process). This will also facilitate formation of a very satisfactory ion conduction path in the active material-containing layer of the electrode.

The electrode formed using the composite particles has three-dimensional and adequately large contact interfaces between the conductive additive, electrode active material and electrolyte (solid electrolyte or liquid electrolyte), which are the reaction sites for the charge transfer reaction proceeding in the active material-containing layer, and the electrical contact between the active material-containing layer and current collector is also very satisfactory.

According to the invention, composite particles are formed beforehand having very satisfactory dispersed states of the conductive additive, electrode active material and binder, and therefore the amount of conductive additive and binder added can be adequately reduced compared to the prior art.

When a conductive polymer is used according to the invention, the conductive polymer may be the same as or different from the conductive polymer as a structural element of the composite particles described above.

Also according to the invention, the electrode active material may be an active material which can be used for the cathode of a primary battery or secondary battery. Alternatively, the electrode active material of the invention may be an active material which can be used for the anode of a primary battery or secondary battery. Also, the electrode active material of the invention may be a carbon material or metal oxide having electron conductivity, which can be used for the electrode of an electrolytic cell or capacitor. According to the invention, an electrolytic cell or capacitor is an electrochemical cell provided with at least a first electrode (anode), a second electrode (cathode) and an electrolyte layer with ion conductivity, and having a construction wherein the first electrode (anode) and second electrode (cathode) are situated in an opposing manner via an electrolyte layer. Throughout the present specification, the term “capacitor” is used synonymously with “condenser”.

The electrode of the invention having the construction described above may be used in an electrochemical device, i.e. in an electrochemical capacitor such as an electrical double layer capacitor, or in a battery such as a lithium ion secondary battery. The electrochemical device may also be used as a backup power source for cellular phones and the like (small electrical devices) or as an auxiliary power source for hybrid vehicles.

The present invention further provides an electrochemical device comprising an anode and cathode situated in a mutually opposing manner, and an electrolyte layer having ion conductivity situated between the anode and cathode,

wherein either or both the anode or cathode has at least a conductive active material-containing layer comprising, as the structural material, composite particles composed of an electrode active material, a conductive additive with an electron conductive property, and a binder capable of binding the electrode active material and the conductive additive, and a current collector situated in electrical contact with the active material-containing layer,

the composite particles are formed by a granulating step in which the conductive additive and binder are bonded to and integrated with particles made of the electrode active material,

the active material-containing layer is formed by a dry sheet-forming step wherein the powder comprising at least the composite particles obtained by the granulating step is subjected to pressurization treatment to form a sheet in order to obtain a sheet containing at least the composite particles, and an active material-containing layer placement step wherein the sheet is placed as an active material-containing layer at a position on the current collector where the active material-containing layer is to be formed, and

the electrode active material and conductive additive are non-isolated and electrically linked in the active material-containing layer.

The electrode of the invention having an active material-containing layer comprising the aforementioned specific composite particles is provided with at least one of, and preferably both, the anode and cathode, so that it is possible to easily and reliably construct an electrochemical device whereby adequate energy density can be achieved even when the thickness of the electrode active material-containing layer is 100 μm or greater (or even 120 μm or greater).

According to the invention, an “electrochemical device” is one having a construction comprising at least a mutually opposing first electrode (anode) and second electrode (cathode), and at least an electrolyte layer with ion conductivity situated between the first electrode and second electrode. An “electrolyte layer with ion conductivity” is (1) a layer which is a porous separator formed from an insulating material, having an electrolyte solution (or a gel-like electrolyte obtained by adding a gelling agent to an electrolyte solution) impregnated into its interior, (2) a solid electrolyte film (a film comprising a solid polymer electrolyte or a film containing an ion conductive inorganic material), (3) a layer comprising an gel-like electrolyte obtained by adding a gelling agent to the electrolyte solution, or (4) a layer comprising an electrolyte solution.

Any of the aforementioned constructions (1) to (4) may also have constructions wherein the interiors of the first electrode and second electrode also contain the respective electrolytes used.

Throughout the present specification, the laminated body comprising the first electrode (anode), electrolyte layer and second electrode (cathode) in constructions (1) to (3) will be referred to as “elements” as necessary. The elements may also have constructions of five or more layers, including the electrode and electrolyte layer mutually laminated in addition to the 3-layer structure, as with constructions (1) to (3).

In any of the aforementioned constructions (1) to (4), the electrochemical device may also have the construction of a module wherein a plurality of unit cells are situated in a single case either serially or in parallel.

The electrochemical device of the invention may be characterized in that the electrolyte layer comprises a solid electrolyte. In this case, the solid electrolyte will be characterized by comprising a ceramic solid electrolyte, a solid polymer electrolyte or a gel-like electrolyte obtained by adding a gelling agent to a liquid electrolyte.

In this case, it is possible to construct an electrochemical device wherein all of the constituents are solid (for example, an “all-solid battery”). This will make it possible to more easily achieve lighter weight, improved energy density and enhanced safety for the electrochemical device.

When an “all-solid battery” is constructed (particularly when an all-solid lithium ion secondary battery is constructed) as the electrochemical device, the following advantages (I) to (IV) will be obtained. Specifically, (I) since the electrolyte layer is composed not of a liquid electrolyte solution but rather a solid electrolyte, there will be no liquid leakage, excellent heat resistance (high-temperature stability) will be achieved, and reaction between the electrolyte components and electrode active material can be adequately prevented. The resulting battery will therefore exhibit excellent stability and reliability. (II) The use of metal lithium as the anode, which has been difficult with electrolyte layers composed of liquid electrolyte solutions (construction of “metal lithium secondary batteries”), is facilitated and further improved energy density can be achieved. (III) When the construction is as a module having a plurality of unit cells situated in a single case, it is possible to achieve serial connection of the plurality of unit cells, which has been impossible to realize with electrolyte layers composed of liquid electrolyte solutions. Consequently, it becomes possible to construct modules having various output voltages, and especially relatively large output voltages. (IV) It becomes easily possible to construct compact batteries with greater freedom of feasible battery shapes, compared to using electrolyte layers composed of liquid electrolyte solutions. These can therefore be easily applied as power sources under various mounting conditions (mounting positions, mounting spaces sizes, mounting spaces shapes, etc.) for portable devices such as cellular phones.

The electrochemical device of the invention may also be characterized in that the electrolyte layer comprises a separator composed of an insulating porous body, and a liquid electrolyte or solid electrolyte impregnated into the separator. In this case as well, when using a solid electrolyte, it may be a ceramic solid electrolyte, a solid polymer electrolyte or a gel-like electrolyte obtained by adding a gelling agent to a liquid electrolyte.

The present invention further provides a method for manufacturing an electrode having at least a conductive active material-containing layer comprising an electrode active material, and a current collector situated in electrical contact with the active material-containing layer,

the process for manufacturing an electrode comprising

a granulating step in which a conductive additive and a binder capable of binding the electrode active material and the conductive additive are bonded to and integrated with particles made of the electrode active material to form composite particles comprising the electrode active material, the conductive additive and the binder,

a dry sheet-forming-forming step in which powder comprising at least the composite particles obtained by the granulating step is subjected to pressurization treatment to form a sheet in order to obtain a sheet containing at least the composite particles, and

an active material-containing layer placement step in which the sheet is placed at the location of the current collector at which the active material-containing layer is to be formed, as the active material-containing layer,

wherein the granulating step comprises

a stock solution preparation step wherein a stock solution containing a binder, conductive additive and solvent is prepared,

a fluidized bed forming step wherein the particles made of the electrode active material are introduced into a fluidizing tank to form a fluidized bed of the particles made of the electrode active material, and

a spray drying step wherein the stock solution is sprayed in the fluidized bed containing the particles made of the electrode active material to attach and dry the stock solution onto the particles made of the electrode active material, the solvent is removed from the stock solution attached to the surfaces of the particles made of the electrode active material, and the particles made of the electrode active material are bonded to the particles made of the conductive additive by the binder.

By carrying out the granulating step described above, it is possible to easily and reliably form composite particles made of the structural material of the electrode of the invention as described above.

Also, by forming the active material-containing layer by a dry process using composite particles in the dry sheet-forming step, it is possible to more reliably obtain an electrode having adequately reduced internal resistance and being easily capable of sufficient increase in energy density of the electrochemical device.

The powder used for the dry sheet-forming step, i.e. the “powder comprising at least the composite particles”, may consist solely of the composite particles. The powder may also contain a binder and/or a conductive additive. When the powder contains constituent components other than the composite particles, the proportion of the composite particles in the powder is preferably 80 wt % or greater based on the total weight of the powder.

By using composite particles obtained by the granulating step and forming an active material-containing layer by a dry process using the composite particles in the dry sheet-forming step, it is possible to more easily and reliably form an electrode having excellent electrode characteristics, such as polarization characteristics, and therefore an electrochemical device capable of sufficient energy density can be easily and reliably constructed even when the thickness of the electrode active material-containing layer is 100 μm or greater. In particular, by using the manufacturing method of the invention it is possible to easily produce a high-output electrode with a relatively thick active material-containing layer (for example, an electrode with an active material-containing layer thickness of 150-1000 μm), which has been difficult to obtain not only by conventional dry processes but also by conventional wet processes.

In the granulating step of the electrode produce method of the invention, the reference to “the conductive additive and binder are bonded to and integrated with particles made of the electrode active material” means that particles made of the conductive additive and particles made of the binder are each in contact with at least a portion of the surfaces of the particles made of the electrode active material. That is, it is sufficient if a portion of the surfaces of the particles made of the electrode active material is covered by the particles made of the conductive additive and the particles made of the binder, and it is not necessary for them to be completely covered. The “binder” used in the granulating step of the composite particle manufacturing method of the invention is one also capable of binding the electrolyte active material and conductive additive used.

From the standpoint of more reliably obtaining the aforementioned effect of the invention, heat treatment is preferably carried out with the pressurization treatment in the dry sheet-forming step. Also, from the standpoint of achieving uniform shapes and sizes of the obtained composite particles, an air stream is preferably generated in the fluidizing tank during the fluidizing bed forming step and the particles made of the electrode active material are introduced into the air stream to form a fluidized bed of the particles made of the electrode active material.

From the standpoint of more easily and reliably forming an active material-containing layer having the construction described above in the electrode manufacturing method of the invention, the powder comprising at least the composite particles used in the dry sheet-forming step is preferably a powder composed solely of the composite particles.

The electrode manufacturing method of the invention may be characterized in that the powder comprising at least composite particles used in the dry sheet-forming step further contains a conductive additive and/or binder.

From the standpoint of more easily and more reliably forming an active material-containing layer having the structure described above in the electrode manufacturing method of the invention, the active material-containing layer is preferably formed so that the thickness T satisfies the condition represented by the following inequality (1).
100 μm≦T≦2000 μm (1)

From the standpoint of more easily and more reliably forming an active material-containing layer having the structure described above in the electrode manufacturing method of the invention, there are preferably used composite particles such that the mean particle size d of the composite particles in the active material-containing layer preferably satisfies the condition represented by the following inequality (2).
10 μm≦d≦2000 μm (2)

In addition, from the standpoint of more easily and more reliably forming an active material-containing layer having the structure described above in the electrode manufacturing method of the invention, the thickness T of the active material-containing layer and the mean particle size d of the composite particles preferably satisfy the condition represented by the following inequality (3).
1/20≦T/d≦200 (3)

Furthermore, preferably, the content of the conductive additive in the active material-containing layer in the electrode manufacturing method of the invention is 0.5-6 wt % based on the total weight of the active material-containing layer,

the content of the binder in the active material-containing layer is 0.5-6 wt % based on the total weight of the active material-containing layer, and

the thickness T of the active material-containing layer satisfies the condition represented by the following inequality (4).
120 μm≦T≦2000 μm (4)

By using conductive additive and binder contents within the ranges specified above in the active material-containing layer, and limiting the thickness of the active material-containing layer to between 120 μm and 200 μm, it is possible to eliminate the problem of conventional electrodes whereby the internal resistance increases if the thickness of the active material-containing layer is 120 μm or greater, and to thus more easily and reliably achieve high energy densification of the electrochemical device.

From the standpoint of more easily and more reliably forming composite particles having the structure described above according to the invention, the granulating step is preferably carried out while adjusting the temperature of the fluidizing tank to a temperature above 50° C. but not largely exceeding the melting point of the binder, and more preferably while adjusting the temperature in the fluidizing tank to above 50° C. and no higher than the melting point of the binder. The melting point of the binder will depend on the type of binder, and may be, for example, about 200° C. If the temperature in the fluidizing tank is below 50° C., there will be a greater tendency for drying of the solvent to be inadequate during the spraying. If the temperature in the fluidizing tank is much higher than the melting point of the binder, the binder will melt, tending to significantly hinder formation of the particles. If the temperature in the fluidizing tank is just slightly higher than the melting point of the binder, it will be possible to adequately prevent this problem by altering the conditions. The problem should not occur if the temperature in the fluidizing tank is below the melting point of the binder.

From the standpoint of more easily and more reliably forming composite particles having the structure described above in the composite particle manufacturing method of the invention, the granulating step is preferably carried out with an air stream in the fluidizing tank composed of one gas selected from among air, nitrogen gas and inert gases. Also, the humidity (relative humidity) in the fluidizing tank for the granulating step is preferably no greater than 30% in the preferred temperature range mentioned above. An “inert gas” is any gas belonging to the noble gas family.

According to the electrode manufacturing method of the invention, the solvent in the stock solution used in the granulating step is preferably one capable of dissolving or dispersing the binder while also dispersing the conductive additive. This will also further increase the dispersability of the binder, conductive additive and electrode active material in the composite particles. From the standpoint of further increasing the dispersability of the binder, conductive additive and electrode active material in the composite particles, the solvent in the stock solution is more preferably one capable of dissolving the binder and dispersing the conductive additive.

According to the electrode manufacturing method of the invention, a conductive polymer may also be dissolved in the stock solution for the granulating step. In this case as well, the obtained composite particles will also contain the conductive polymer. By using such composite particles it is possible to form the polymer electrode described earlier. The conductive polymer may be one with ion conductivity or with electron conductivity. When the conductive polymer is one with ion-conductivity, it is possible to more easily and more reliably form a very satisfactory ion conduction path (ion conduction network) in the electrode active material-containing layer. When the conductive polymer is one with electron conductivity, it is possible to more easily and more reliably form a very satisfactory electron conduction path (electron conduction network) in the electrode active material-containing layer.

The electrode manufacturing method of the invention may also be characterized in that a conductive polymer is used as the binder. This will yield composite particles which further comprise a conductive polymer. By using such composite particles it is possible to form a polymer electrode as described above. The conductive polymer may be one with ion conductivity or with electron conductivity. When the conductive polymer is one with ion conductivity, it is possible to more easily and more reliably form a very satisfactory ion conduction path (ion conduction network) in the electrode active material-containing layer. When the conductive polymer is one with electron conductivity, it is possible to more easily and more reliably form a very satisfactory electron conduction path (electron conduction network) in the electrode active material-containing layer.

By using composite particles obtained by the electrode manufacturing method of the invention as described above, it is possible to easily and reliably obtain an electrode having excellent polarization characteristics. In addition, by using this electrode as either of, and preferably both, the anode and cathode, it is possible to easily and reliably form an electrochemical device having excellent charge-discharge characteristics.

According to the electrode manufacturing method of the invention, the dry sheet-forming process is preferably carried out using a press machine, such as a roll press machine. A roll press machine has a construction with a pair of rolls, with the “powder containing at least the composite particles” being introduced between the pair of rolls and pressurized to form a sheet. Also, heat treatment may be combined with the pressurization treatment if necessary, and when they are carried out simultaneously, a hot press machine such as a hot roll press machine may be used. This will allow a sheet comprising the active material-containing layer to be formed in an easy and reliable manner. However, from the standpoint of more easily and reliably forming a sheet comprising active material-containing layer, heat treatment is preferably carried out in addition to the pressurization treatment.

The present invention still further provides a method for manufacturing an electrochemical device provided with an anode and cathode situated in a mutually opposing manner, and an electrolyte layer having ion conductivity situated between the anode and the cathode,

the method for manufacturing an electrochemical device employing an electrode

wherein either or both the anode or cathode has at least a conductive active material-containing layer comprising, as the structural material, composite particles composed of an electrode active material, a conductive additive with an electron conductive property, and a binder capable of binding the electrode active material and the conductive additive, and a current collector situated in electrical contact with the active material-containing layer,

the composite particles are formed by a granulating step in which the conductive additive and binder are bonded to and integrated with particles made of the electrode active material,

the active material-containing layer is formed by a dry sheet-forming step wherein the powder comprising at least the composite particles obtained by the granulating step is subjected to pressurization treatment to form a sheet in order to obtain a sheet containing at least the composite particles, and an active material-containing layer placement step wherein the sheet is placed as an active material-containing layer at a position on the current collector where the active material-containing layer is to be formed, and

the electrode active material and conductive additive are non-isolated and electrically linked in the active material-containing layer.

The electrode used for the manufacturing method for an electrochemical device of the invention is an electrode obtained by the electrode manufacturing method of the invention described above, and by using the electrode for either of, or preferably both, the anode and cathode, it is possible to easily and reliably obtain an electrochemical device having excellent charge-discharge characteristics which adequately meet sudden and drastically varying load demands.

### BRIEF DESCRIPTION OF THE DRAWINGS

FIG. 1 is a schematic cross-sectional view showing the basic construction of a preferred embodiment of an electrochemical device of the invention (lithium ion secondary battery).

FIG. 2 is a schematic cross-sectional view showing an example of the basic construction of composite particles produced by a granulating step for manufacture of electrodes.

FIG. 3 is an illustration showing an example of a granulating step for manufacture of an electrode.

FIG. 4 is an illustration showing an example of a dry sheet-forming step for manufacture of an electrode by a dry process.

FIG. 5 is a schematic cross-sectional view showing a simplified view of the internal structure in the active material-containing layer of an electrode of the invention.

FIG. 6 is a schematic cross-sectional view showing the basic construction of another embodiment of an electrochemical device of the invention.

FIG. 7 is a perspective view showing the basic construction of still another embodiment of an electrochemical device of the invention.

FIG. 8 is an SEM photograph taken of a cross-section of the active material-containing layer of an electrode (electric double layer capacitor) produced by the manufacturing process (dry process) of the invention.

FIG. 9 is a TEM photograph taken of a cross-section (the same portion as shown in FIG. 8) of the active material-containing layer of an electrode (electric double layer capacitor) produced by the manufacturing process (dry process) of the invention.

FIG. 10 is an SEM photograph taken of a cross-section of the active material-containing layer of an electrode (electric double layer capacitor) produced by the manufacturing process (dry process) of the invention.

FIG. 11 is a TEM photograph taken of a cross-section (the same portion as shown in FIG. 10) of the active material-containing layer of an electrode (electric double layer capacitor) produced by the manufacturing process (dry process) of the invention.

FIG. 12 is an SEM photograph taken of a cross-section of the active material-containing layer of an electrode (electric double layer capacitor) produced by the manufacturing process (dry process) of the invention.

FIG. 13 is a TEM photograph taken of a cross-section (the same portion as shown in FIG. 12) of the active material-containing layer of an electrode (electric double layer capacitor) produced by the manufacturing process (dry process) of the invention.

FIG. 14 is an SEM photograph taken of a cross-section of the active material-containing layer of an electrode (electric double layer capacitor) produced by a manufacturing process (wet process) of the prior art.

FIG. 15 is a TEM photograph taken of a cross-section (the same portion as shown in FIG. 14) of the active material-containing layer of an electrode (electric double layer capacitor) produced by a manufacturing process (wet process) of the prior art.

FIG. 16 is an SEM photograph taken of a cross-section of the active material-containing layer of an electrode (electric double layer capacitor) produced by a manufacturing process (wet process) of the prior art.

FIG. 17 is a TEM photograph taken of a cross-section (the same portion as shown in FIG. 16) of the active material-containing layer of an electrode (electric double layer capacitor) produced by a manufacturing process (wet process) of the prior art.

FIG. 18 is an SEM photograph taken of a cross-section of the active material-containing layer of an electrode (electric double layer capacitor) produced by a manufacturing process (wet process) of the prior art.

FIG. 19 is a TEM photograph taken of a cross-section (the same portion as shown in FIG. 18) of the active material-containing layer of an electrode (electric double layer capacitor) produced by a manufacturing process (wet process) of the prior art.

FIG. 20 is a schematic cross-sectional view showing a simplified view of the partial construction of electrode composite particles of the prior art, and the internal structure in the active material-containing layer of an electrode formed using electrode composite particles of the prior art.

FIG. 21 is an SEM photograph taken of a cross-section of the active material-containing layer of an electrode (electric double layer capacitor) produced by a manufacturing process (wet process) of the prior art.

FIG. 22 is an enlargement of the photograph region R100 shown in FIG. 21.

FIG. 23 is an enlargement of the photograph region R102 shown in FIG. 21.

FIG. 24 is an enlargement of the photograph region R104 shown in FIG. 22.

FIG. 25 is an enlargement of the photograph region R112 shown in FIG. 23.

FIG. 26 is an enlargement of the photograph region R120 shown in FIG. 23.

### DETAILED DESCRIPTION OF THE INVENTION

Preferred embodiments of the invention will now be explained in detail with respect to the accompanying drawings. Throughout the explanation, identical or corresponding members will be indicated by the same reference numerals and will be explained only once.

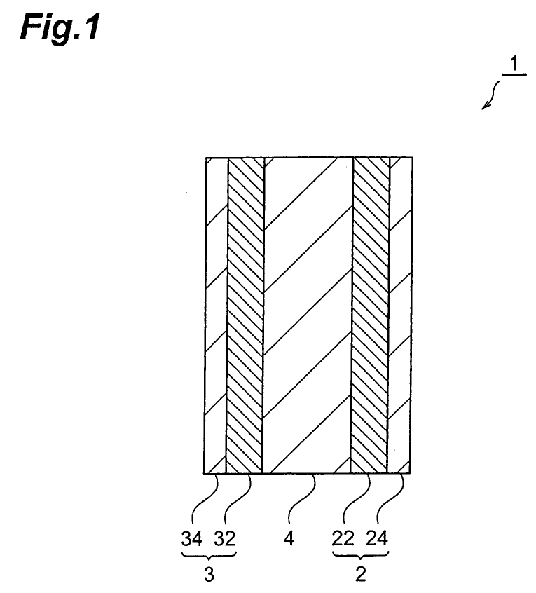

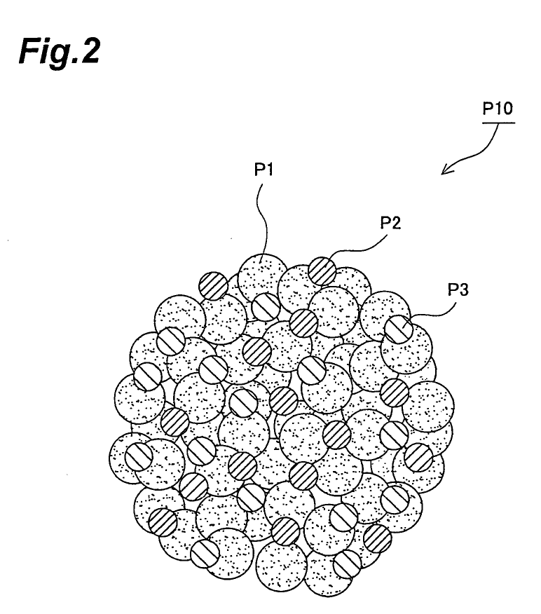

FIG. 1 is a schematic cross-sectional view showing the basic construction of a preferred embodiment of an electrochemical device of the invention (lithium ion secondary battery). FIG. 2 is a schematic cross-sectional view showing an example of the basic construction of composite particles produced by a granulating step for manufacture of electrodes (anode 2 and cathode 3). The secondary battery 1 shown in FIG. 1 is constructed primarily of an anode 2 and cathode 3, and an electrolyte layer 4 situated between the anode 2 and cathode 3.

The secondary battery 1 shown in FIG. 1 is provided with an anode 2 and cathode 3 comprising the composite particles P10 shown in FIG. 2, as explained below, in order to facilitate increase in the energy density of the electrochemical device even when the active material-containing layer thickness is 100 μm or greater.

The anode 2 of the secondary battery 1 shown in FIG. 1 is constructed of a film-like (laminar) current collector 24, and a film-like active material-containing layer 22 situated between the current collector 24 and the electrolyte layer 4. During charge, the anode 2 is connected to the anode of an external power source (not shown), and functions as a cathode. The shape of the anode 2 is not particularly restricted, and for example, it may be a thin-film as shown in the drawing. The current collector 24 of the anode 2 may be, for example, a copper foil. A thin conductive adhesive layer composed mainly of a conductive additive and binder may be used on the current collector (current collector foil). The adhesive layer facilitates satisfactory maintenance of the state of adhesion between the current collector and the active material-containing layer, while also adequately reducing the electrical contact resistance compared to direct contact between the current collector and active material-containing layer, and satisfactorily conserving the conductive property of the electrode. In addition, since the adhesive layer is a thermal adhesive layer having a property which utilizes heat for adhesion to the current collector, it is possible to more easily produce an electrode using the adhesive layer.

The active material-containing layer 22 of the anode 2 is constructed primarily of the composite particles P10 shown in FIG. 2. Also, the composite particles P10 are composed of particles P1 made of the electrode active material, particles P2 made of the conductive additive, and particles P3 made of the binder. The mean particle size of the composite particles P10 is not particularly restricted, but is preferably 10-200 μm. The composite particles P10 have a structure wherein the particles P1 made of the electrode active material and the particles P2 made of the conductive additive are non-isolated and electrically linked. Consequently, a structure is also formed in the active material-containing layer 22, wherein the particles P1 made of the electrode active material and the particles P2 made of the conductive additive are non-isolated and electrically linked.

The electrode active material composing the composite particles P10 in the anode 2 is not particularly restricted, and may be a publicly known electrode active material. For example, there may be mentioned carbon materials such as graphite, non-graphitizing carbon, graphitizing carbon and low-temperature firing carbon, metals capable of forming compounds with lithium, such as Al, Si and Sn, amorphous compounds composed mainly of oxides such as SiO₂ and SnO₂, and lithium titanate (Li₃Ti₅O₁₂), or the like, which are capable of intercalation and deintercalation (occlusion and release, or doping and dedoping) of lithium ions.

The conductive additive composing the composite particles P10 in the anode 2 is not particularly restricted, and may be a publicly known conductive additive. For example, there may be mentioned carbon materials such as carbon blacks, high-crystalline artificial graphite and natural graphite, metal fine powders of copper, nickel, stainless steel, iron and the like, mixtures of the aforementioned carbon materials and metal fine powders, and conductive oxides such as ITO.

The binder composing the composite particles P10 in the anode 2 is not particularly restricted so long as it is capable of binding the particles of the electrode active material and the particles P2 made of the conductive additive. For example, there may be mentioned fluorine resins such as polyvinylidene fluoride (PVDF), polytetrafluoroethylene (PTFE), tetrafluoroethylene-hexafluoropropylene copolymer (FEP), tetrafluoroethylene-perfluoroalkylvinyl ether copolymer (PFA), ethylene-tetrafluoroethylene copolymer (ETFE), polychlorotrifluoroethylene (PCTFE), ethylene-chlorotrifluoroethylene copolymer (ECTFE) and polyvinyl fluoride (PVF). The binder not only binds the aforementioned particles P1 made of the electrode active material and particles P2 made of the conductive additive, but also contributes to binding between the foil (current collector 24) and composite particles P10.

In addition to the resins mentioned above for the binder, there may be used vinylidene fluoride-based fluororubber compounds such as, for example, vinylidene fluoride-hexafluoropropylene based fluororubber (VDF-HFP based fluororubber), vinylidene fluoride-hexafluoropropylene-tetrafluoroethylene based fluororubber (VDF-HFP-TFE based fluororubber), vinylidene fluoride-pentafluoropropylene based fluororubber (VDF-PFP based fluororubber), vinylidene fluoride-pentafluoropropylene-tetrafluoroethylene based fluororubber (VDF-PFP-TFE based fluororubber), vinylidene fluoride-perfluoromethylvinyl ether-tetrafluoroethylene based fluororubber (VDF-PFMVE-TFE based fluororubber), and vinylidene fluoride-chlorotrifluoroethylene based fluororubber (VDF-CTFE based fluororubber).

In addition to the compounds mentioned above for the binder, there may be used, for example, polyethylene, polypropylene, polyethylene terephthalate, aromatic polyamides, cellulose, styrene-butadiene rubber, isoprene rubber, butadiene rubber, ethylene-propylene rubber and the like. There may also be used thermoplastic elastomer polymers such as styrene-butadiene-styrene block copolymer, hydrogenated forms thereof, styrene-ethylene-butadiene-styrene copolymer, styrene-isoprene-styrene block copolymer, and hydrogenated forms thereof; syndiotactic 1,2-polybutadiene, ethylene-vinyl acetate copolymer, and propylene-α-olefin (C2-12) copolymers; and conductive polymers.

The composite particles P10 may also contain particles made of a conductive polymer, added as a constituent component of the composite particles P10. When forming an electrode by a dry process using the composite particles P10, they may be added as a constituent component of a powder comprising at least the composite particles.

The conductive polymer is not particularly restricted so long as it has lithium ion conductivity. As examples there may be mentioned complexes of a monomer of a polymer compound (a polyether-based polymer compound such as polyethylene oxide or polypropylene oxide, a crosslinked polymer of a polyether compound, or polyepichlorhydrin, polyphosphazene, polysiloxane, polyvinylpyrrolidone, polyvinylidene carbonate, polyacrylonitrile or the like), with a lithium salt such as LiClO₄, LiBF₄, LiPF₆, LiAsF₆, LiCl, LiBr, Li(CF₃SO₂)₂N or LiN(C₂F₅SO₂)₂, or an alkali metal salt composed mainly of lithium. The polymerization initiator used for formation of the complex may be, for example, a photopolymerization initiator or thermal polymerization initiator suited for the particular monomer used.

When the secondary battery 1 is to be constructed as a metal lithium secondary battery, the anode (not shown) may be an electrode composed solely of metal lithium or a lithium alloy, also serving as the current collector. There are no particular restrictions on a lithium alloy, and for example, there may be mentioned alloys such as Li—Al, LiSi and LiSn (where LiSi is also treated as an alloy). In this case, the cathode is constructed using composite particles P10 having the construction described hereunder.

The cathode 3 of the secondary battery 1 shown in FIG. 1 is constructed of a film-like current collector 34 and a film-like active material-containing layer 32 situated between the current collector 34 and the electrolyte layer 4. During charge, the cathode 3 is connected to the cathode of an external power source (not shown), and functions as an anode. The shape of the cathode 3 is not particularly restricted, and for example, it may be a thin-film as shown in the drawing. The current collector 34 of the cathode 3 may be, for example, an aluminum foil. A thin conductive adhesive layer composed mainly of a conductive additive and binder may be used on the current collector 34 (for example, aluminum foil). The adhesive layer facilitates satisfactory maintenance of the state of adhesion between the current collector and the active material-containing layer, while also adequately reducing the electrical contact resistance compared to direct contact between the current collector and active material-containing layer, and satisfactorily conserving the conductive property of the electrode. In addition, since the adhesive layer is a thermal adhesive layer having a property which utilizes heat for adhesion to the current collector, it is possible to more easily produce an electrode using the adhesive layer.

The electrode active material composing the composite particles P10 in the cathode 3 is not particularly restricted, and may be a publicly known electrode active material. For example, there may be mentioned lithium cobaltate (LiCoO₂), lithium nickelate (LiNiO₂), lithium manganese spinel (LiMn₂O₄) and complex metal oxides represented by the general formula: LiNiₓMn_{y}Co_{z}O₂ (x+y+z=1), lithium vanadium compounds, V₂O₅, olivine LiMPO₄ (where M represents Co, Ni, Mn or Fe), lithium titanate (Li₃Ti₅O₁₂), and the like.

Each of the constituent elements other than the electrode active material composing the composite particles P10 in the cathode 3 may be made of the same materials as those composing the composite particles P10 in the anode 2. The binder used in the composite particles P10 of the cathode 3 not only binds the particles P1 made of the electrode active material and the particles P2 of the conductive additive, but also contributes to binding between the foil (current collector 34) and the composite particles P10. As explained above, the composite particles P10 have a construction wherein the particles P1 made of the electrode active material and the particles P2 made of the conductive additive are non-isolated and electrically linked. Consequently, a structure is also formed in the active material-containing layer 32, wherein the particles P1 made of the electrode active material and the particles P2 made of the conductive additive are non-isolated and electrically linked.

Here, the content of the conductive additive in each composite particle P10 is preferably 0.5-6 wt % based on the total weight of the composite particle P10. If the conductive additive content is less than 0.5 wt %, the amount of the conductive additive will be too small, tending to prevent formation of a suitable conductive network in the composite particles. If the conductive additive content exceeds 6 wt %, the amount of the conductive additive not contributing to the electrical capacity will be greater, tending to make it difficult to obtain sufficient volume energy density.

The content of the binder in each composite particle P10 is preferably 0.5-6 wt % based on the total weight of the composite particles P10. If the binder content is less than 0.5 wt %, the amount of binder will be too small, tending to prevent formation of firm composite particles. If the binder content exceeds 6 wt %, the amount of binder not contributing to the electrical capacity will be greater, tending to make it difficult to obtain sufficient volume energy density. In this case, a low electron conductivity of the binder will tend to increase the electrical resistance of the composite particles, and prevent sufficient electrical capacity from being obtained.

From the standpoint of forming three-dimensional and adequately large contact interfaces between the conductive additive, electrode active material and solid polymer electrolyte, the BET specific surface area of the particles P1 made of each electrode active material in the anode 2 and cathode 3 is preferably 0.1-1.0 m²/g and more preferably 0.1-0.6 m²/g for the cathode 3. It is preferably 0.1-10 m²/g and more preferably 0.1-5 m²/g for the anode 2. In the case of a double layer capacitor, it is preferably 500-3000 m²/g for both the cathode 3 and anode 2.

From the same standpoint, the mean particle size of the particles P1 made of each electrode active material is preferably 5-20 μm, and more preferably 5-15 μm for the cathode 3. It is preferably 1-50 μm and more preferably 1-30 μm for the anode 2. Also from the same standpoint, the amount of conductive additive and binder adhering to the electrode active material is preferably 1-12 wt % and more preferably 3-12 wt %, when expressed as the value of 100×(weight of conductive additive+weight of binder)/(weight of composite particle).

The electrolyte layer 4 may be a layer composed of an electrolyte solution, a layer composed of a solid electrolyte (ceramic solid electrode, solid polymer electrolyte) or a layer composed of a separator and an electrolyte solution and/or solid electrolyte impregnated in the separator.

The electrolyte solution is prepared by dissolving a lithium-containing electrolyte in a non-aqueous solvent. The lithium-containing electrolyte may be appropriately selected from among LiClO₄, LiBF₄, LiPF₆ and the like, and there may be used lithium imide salts such as Li(CF₃SO₂)₂N and Li(C₂F₅SO₂)₂N, or LiB(C₂O₄)₂ or the like. As non-aqueous solvents there may be used, for example, ethers, ketones, carbonates and the like, which may be selected from among the organic solvents listed in Japanese Unexamined Patent Publication SHO No. 63-121260, but carbonates are particularly preferred according to the invention.

Among carbonates, there are most preferably used mixed solvents composed mainly of ethylene carbonate and having one or more other solvents added thereto. The mixing ratio is preferably ethylene carbonate:other solvent=5-70:95-30 (volume ratio) in most cases. Ethylene carbonate has a high congealing point of 36.4° C. and therefore congeals at ordinary temperature, such that ethylene carbonate alone cannot be used as a battery electrolyte solution; however, if at least one other solvent with a low congealing point is added, the congealing point of the mixes solvent will be lowered enough to permit its use.

The other solvent used in this case may be any one which lowers the congealing point of ethylene carbonate. For example, there may be mentioned diethyl carbonate, dimethyl carbonate, propylene carbonate, 1,2-dimethoxyethane, methylethyl carbonate, γ-butyrolactone, γ-valerolactone, γ-octanoiclactone, 1,2-diethoxyethane, 1,2-ethoxymethoxyethane, 1,2-dibutoxyethane, 1,3-dioxolanane, tetrahydrofuran, 2-methyltetrahydrofuran, 4,4-dimethyl-1,3-dioxane, butylene carbonate, methyl formate, and the like. By using a carbonaceous substance as the active material of the anode and using the aforementioned mixed solvent, it is possible to notably improve the battery capacity and adequately lower the irreversible capacitance.

As solid polymer electrolytes there may be mentioned, for example, conductive polymers with ion conductivity.

The conductive polymer is not particularly restricted so long as it has a lithium ion conducting property, and for example, there may be mentioned complexes of a monomer of a polymer compound (a polyether-based polymer compound such as polyethylene oxide or polypropylene oxide, a crosslinked polymer of a polyether compound, or polyepichlorhydrin, polyphosphazene, polysiloxane, polyvinylpyrrolidone, polyvinylidene carbonate, polyacrylonitrile or the like), with a lithium salt such as LiClO₄LiBF₄, LiPF₆, LiAsF₆, LiCl, LiBr, Li(CF₃SO₂)₂N or LiN(C₂F₅SO₂)₂, or an alkali metal salt composed mainly of lithium. The polymerization initiator used for formation of the complex may be, for example, a photopolymerization initiator or thermal polymerization initiator suited for the particular monomer used.

As examples of supporting electrolytes for the polymer solid electrolyte there may be mentioned salts such as LiClO₄, LiPF₆, LiBF₄, LiAsF₆, LiCF₃SO₃, LiCF₃CF₂SO₃, LiC(CF₃SO₂)₃, LiN(CF₃SO₂)₂, LiN(CF₃CF₂SO₂)₂, LiN(CF₃SO₂) (C₄F₉SO₂) and LiN(CF₃CF₂CO)₂, or mixtures thereof.

When a separator is used as the electrolyte layer 4, the structural material may be, for example, one or more polyolefins such as polyethylene, polypropylene or the like (or in the case of two or more, a laminated film of two or more layers), a polyester such as polyethylene terephthalate, a thermoplastic fluororesin such as ethylene-tetrafluoroethylene copolymer, a cellulose, or the like. The form of the sheet may be a fine porous film, woven fabric, nonwoven fabric or the like with a thickness of 5-100 μm and having a gas permeability of about 5-2000 sec/100 cc as measured by the method specified in JIS-P8117. The monomer of the solid electrolyte may also be impregnated and hardened in the separator for use in polymerized form. The electrolyte solution mentioned above may also be used by impregnation into a porous separator.

A preferred embodiment of the electrode manufacturing method of the invention will now be explained.

The composite particles P10 are formed by a granulating step wherein the conductive additive and binder are bonded to and integrated with the particles P1 made of the electrode active material, to form composite particles comprising the electrode active material, the conductive additive and the binder. This granulating step will now be explained.

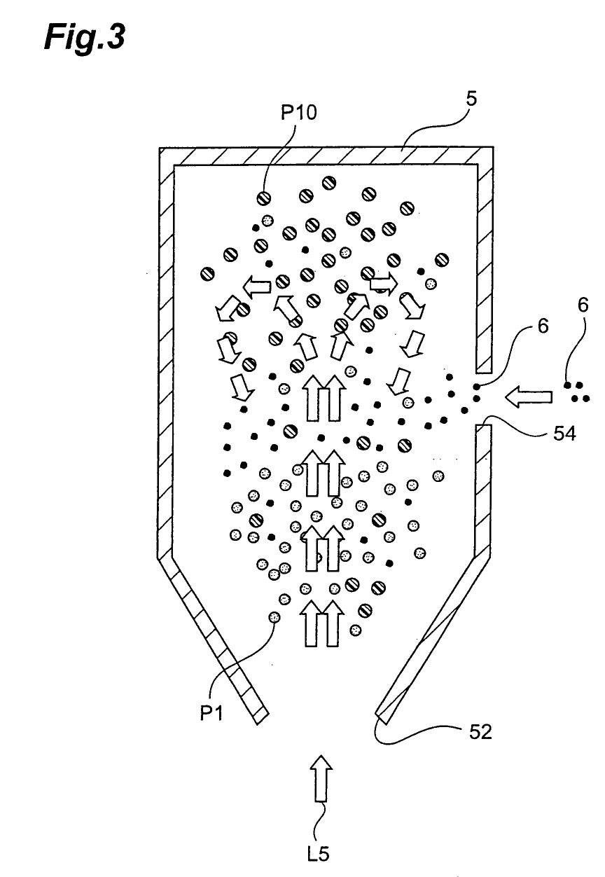

FIG. 3 is an illustration showing an example of a granulating step for production of composite particles. The granulating step comprises a stock solution preparation step wherein a stock solution containing a binder, conductive additive and solvent is prepared, a fluidized bed forming step wherein an air stream is generated in a fluidizing tank and particles made of the electrode active material are introduced into the air stream to form a fluidized bed of the particles made of the electrode active material, and a spray drying step wherein the stock solution is sprayed in the fluidized bed containing the particles made of the electrode active material to attach and dry the stock solution onto the particles made of the electrode active material, the solvent is removed from the stock solution attached to the surfaces of the particles made of the electrode active material, and the particles made of the electrode active material are bonded to the particles made of the conductive additive by the binder.

First, in the stock solution preparation step, a solvent capable of dissolving the binder is used to dissolve the binder. The conductive additive is then dispersed in the resulting solution to obtain a stock solution. The solvent used in the stock solution preparation step may also be a dispersing medium capable of dispersing the binder.

Next, in the fluidizing bed forming step, an air stream is generated in a fluidizing tank 5 and particles P1 made of the electrode active material are introduced into the air stream to form a fluidized bed of the particles made of the electrode active material, as shown in FIG. 3.

Next, in the spray drying step, droplets 6 of the stock solution are sprayed in the fluidizing tank 5 to attach the droplets 6 of the stock solution onto the fluidized particles P1 made of the electrode active material while simultaneously drying them in the fluidizing tank 5, after which the solvent is removed from the droplets 6 of the stock solution attached to the surfaces of the particles P1 made of the electrode active material, and the particles P1 made of the electrode active material are bonded to the particles P2 made of the conductive additive by the binder to obtain composite particles P10, as shown in FIG. 3.

More specifically, the fluidizing tank 5 is a cylindrical container, and it is provided with an opening 52 at the bottom through which warm air (or hot air) is introduced from the exterior, for convection of the particles made of the electrode active material in the fluidizing tank 5. On the side of the fluidizing tank 5 there is provided an opening 54 through which the sprayed droplets 6 of the stock solution are introduced against the convected particles P1 made of the electrode active material in the fluidizing tank 5. The droplets 6 of the stock solution containing the binder, conductive additive and solvent are sprayed against the convected particles P1 made of the electrode active material in the fluidizing tank 5.

Here, the temperature of the atmosphere in which the particles P1 made of the electrode active material are placed is held at a prescribed temperature which allows rapid removal of the solvent in the droplets 6 of the stock solution {preferably a temperature of at least 50° C. and not greatly exceeding the melting point of the binder, and more preferably a temperature of at least 50° C. and below the melting point of the binder (for example, 200° C.)} by adjusting the temperature of, for example, the warm air (or hot air), and the liquid film of the stock solution formed on the surfaces of the particles P1 made of the electrode active material is dried simultaneously with spraying of the droplets 6 of the stock solution. This adheres the binder and conductive additive onto the surfaces of the particles made of the electrode active material, to obtain composite particles P10.

The solvent capable of dissolving the binder is not particularly restricted so long as it is capable of dissolving the binder and dispersing conductive additive, and for example, there may be used N-methyl-2-pyrrolidone, N,N-dimethylformamide or the like.

A preferred example of a method of forming an electrode using the composite particles P10 will now be explained.

(Dry process)

The active material-containing layer 22 of the anode 2 and the active material-containing layer 32 of the cathode 3 are used to form an electrode by a dry process using composite particles P10 produced by the granulating step described above, without using a solvent or dispersing medium.

In this case, the active material-containing layer 22 and the active material-containing layer 32 are formed by the following active material-containing layer forming step. The active material-containing layer forming step includes a dry sheet-forming step wherein powder P12 comprising at least the composite particles P10 (preferably powder comprising only the composite particles P10) is subjected to pressurization treatment to form a sheet in order to obtain a sheet 18 containing at least the composite particles, and an active material-containing layer placement step wherein the sheet 18 is placed as an active material-containing layer (the active material-containing layer 22 or active material-containing layer 32) at a position on the current collector. Heat treatment may be combined with the pressurization treatment if necessary for the dry sheet-forming step, and when they are carried out simultaneously, a hot press machine such as a hot roll press machine may be used. However, from the standpoint of more easily and reliably forming a sheet comprising active material-containing layer, heat treatment is preferably carried out in addition to the pressurization treatment.

The dry process is a process by which the electrode is formed without a solvent, and the advantages provided thereby are that 1) it requires no solvent and is therefore safe, 2) since only the particles are rolled without using a solvent, it is easily possible to achieve high densification of the electrode (porous layer), and 3) since no solvent is used, it is possible to avoid the problem which occurs in wet processes, i.e., aggregation and maldistribution of the particles P1 made of the electrode active material, the particles P2 made of the conductive additive which confers conductivity, and the particles P3 made of the binder, during the drying procedure for the liquid film of the electrode-forming coating solution coated onto the current collector.

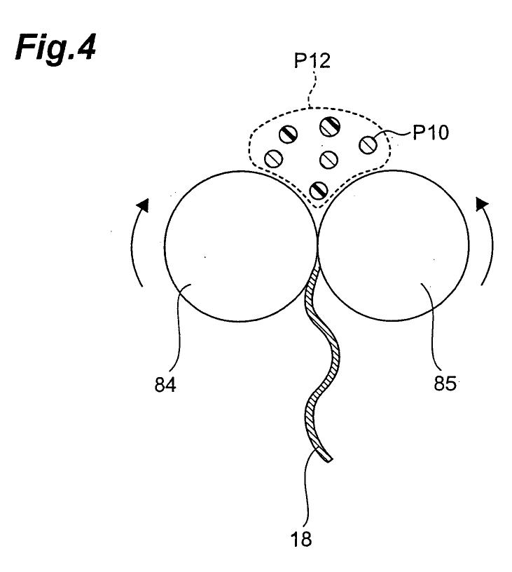

The dry sheet-forming step can be suitably carried out using the roll press machine shown in FIG. 4. When the pressurization treatment and heat treatment are carried out simultaneously, a hot press machine such as a hot roll press machine, may be used.

FIG. 4 is an illustration showing an example of a dry sheet-forming step for manufacture of an electrode by a dry process (when using a hot roll press machine).

Here, as shown in FIG. 4, the powder P12 comprising at least the composite particles P10 is introduced between a pair rolls, a hot roll 84 and hot roll 85, of a hot roll press machine (not shown) and mixing is accomplished with kneading while carrying out rolling by heat and pressure to mold a sheet 18. Here, the surface temperature of the hot roll 84 and hot roll 85 is preferably 60-120° C., and the pressure is preferably 20-5000 kgf/cm.

The powder P12 comprising at least the composite particles P10 may also further contain at least one type of particle from among particles P1 made of the electrode active material, particles P2 made of the conductive additive which confers conductivity, and particles P3 made of the binder.

The powder P12 comprising at least the composite particles P10 may be kneaded beforehand by mixing means such as a mill, before introduction into the hot roll press machine (not shown).

Incidentally, the electrical connection between the current collector and the active material-containing layer may be accomplished by molding the active material-containing layer with a hot roll press machine, but alternatively the current collector and the structural material of the active material-containing layer dispersed on one side of the current collector may be supplied to the hot roll 84 and hot roll 85, to accomplish simultaneous sheet molding of the active material-containing layer and electrical connection between the active material-containing layer and current collector.

When it is attempted to more reliably achieve high output of the electrochemical device by reducing the thickness of the active material-containing layer of the electrode, the active material-containing layer 22 and active material-containing layer 32 are preferably formed in the active material-containing layer forming step in such a manner that the thickness T of the active material-containing layer and the mean particle size d of the composite particles in the active material-containing layer satisfy the conditions represented by the following inequalities (1) to (3).
100 μm≦T≦2000 μm (1)
10 μm≦d≦2000 μm (2)
(1/20)≦(T/d)≦200 (3)

The active material-containing layers (active material-containing layers 22 and 32) are preferably formed on the current collectors (current collector 24 and 34) in the active material-containing layer forming step, in such a manner that the content of the conductive additive in the active material-containing layer is 0.5-6 wt % based on the total weight of the active material-containing layer, the content of the binder is 0.5-6 wt % based on the total weight of the active material-containing layer, and the thickness T of the active material-containing layer satisfies the condition represented by inequality (4) below. This will allow easy and reliable manufacture of an electrochemical device with high energy densification.
120 μm≦T≦2000 μm (4)

In order to satisfy the conditions represented by inequalities (1) to (3) above and further satisfy the condition represented by inequality (4) above as according to this embodiment, the dry sheet-forming step of the active material-containing layer forming step may employ means such as, specifically, 1) adjusting the amount of powder P12 comprising at least the composite particles P1 dispersed on the surface of the hot roll 84 and hot roll 85, or 2) adjusting the pressure for pressurization of the powder P12 by the hot roll 84 and hot roll 85, by adjusting the gap between the hot roll 84 and hot roll 85.

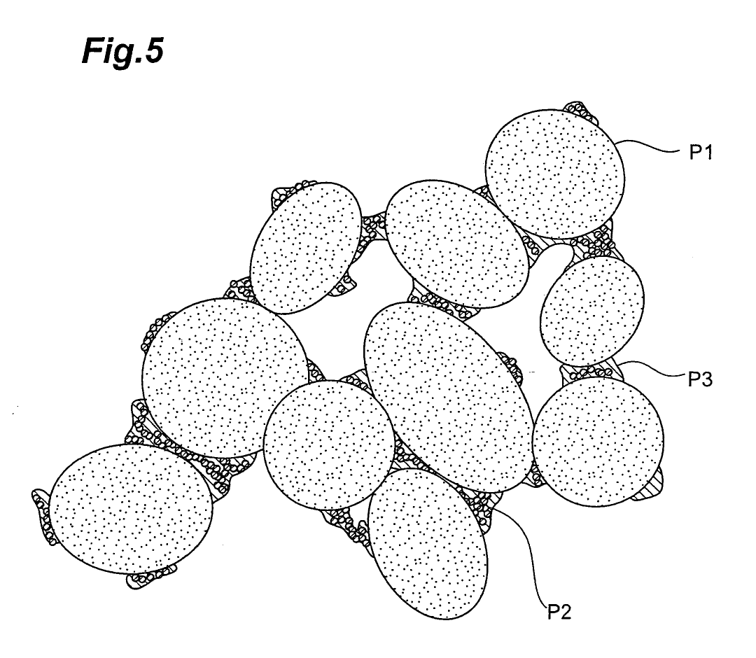

The internal structure schematically shown in FIG. 5 is formed in the active material-containing layer (active material-containing layer 22 or active material-containing layer 32) formed by the dry process described above. Specifically, the structure formed in the active material-containing layer (active material-containing layer 22 or active material-containing layer 32) is such that, even with the use of particles P3 made of the binder, the particles P1 made of the electrode active material and the particles P2 made of the conductive additive are non-isolated and electrically linked.

A preferred embodiment of a process for manufacturing an electrochemical device according to the invention will now be explained. This embodiment is a case in which the electrochemical device is the lithium ion secondary battery 1 mentioned above.

First, an anode 2, cathode 3 and electrolyte layer 4 are prepared. The anode 2 and cathode 3 used may be produced by the electrode manufacturing process described above.

Next, the electrolyte layer 4 is situated between the anode 2 and cathode 3, and the anode 2, cathode 3 and electrolyte layer 4 are integrated to obtain a lithium ion secondary battery 1. Here, the method for integrating the anode 2, cathode 3 and electrolyte layer 4 may be, for example, thermocompression bonding.

Manufacture of a lithium ion secondary battery 1 in this manner provides the following advantages.

In this manufacturing process, the composite particles P10 are formed by a granulating process in which the electrode active material, conductive additive and binder are integrated, and the anode 2 and cathode 3 are formed by a dry sheet-forming step in which the powder comprising the composite particles P10 is sheeted by a dry process. Thus, the electrode active material, conductive additive and binder are bonded together in a very satisfactory dispersed state in the composite particles P10, to create a state wherein the particles P1 made of the electrode active material and the particles P2 made of the conductive additive are non-isolated and electrically linked. Also, since the anode 2 and cathode 3 are formed by the dry sheet-forming step while adequately maintaining the state of the composite particles P10, a very satisfactory electron conduction path is formed in the active material-containing layers 22 and 32 comprising the composite particles P10 composing the anode 2 and cathode 3. As a result, the lithium ion secondary battery 1 employing the anode 2 and cathode 3 has adequately reduced internal resistance and sufficient energy density.

A preferred embodiment of the invention was explained above, but it will be readily appreciated that the invention is not limited to this embodiment.

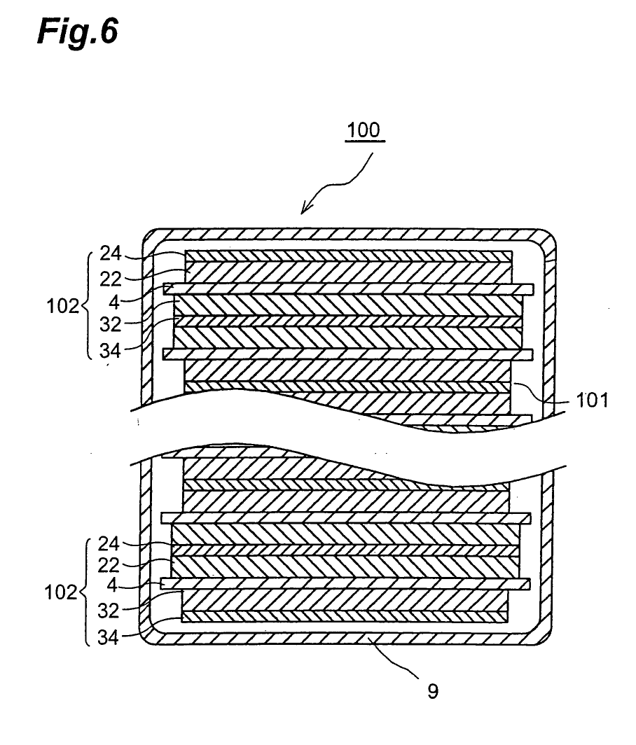

For example, the electrode of the invention may have an active material-containing layer formed using composite particles P10 contained in an electrode-forming coating solution of the invention, with no particular restrictions on the rest of its structure. It is also sufficient if the electrochemical device is provided with an electrode of the invention as either of the anode or cathode, with no particular restrictions on the other aspects of its construction or structure. For example, when the electrochemical device is a battery, as shown in FIG. 6, it may have a construction of a module 100 wherein a plurality of unit cells (cells comprising anode 2, cathode 3, and electrolyte layer 4 also serving as separator) 102 are laminated and held (packaged) in a sealed state in a prescribed case 9.

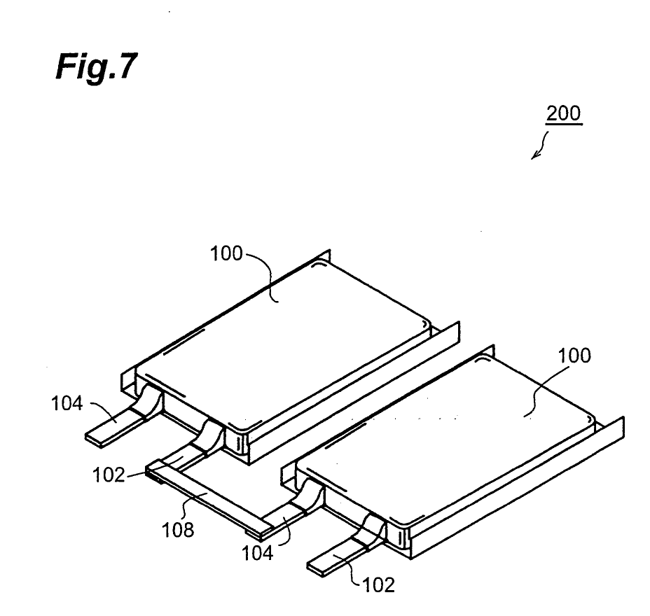

In this case, the unit cells may be connected in parallel, or they may be connected in series. For example, a battery unit may be constructed of a plurality of modules 100 electrically connected in series or parallel. The battery unit may have the cathode terminal 104 of one module 100 and the anode terminal 102 of another module 100 electrically connected by a metal tab 108, as in the battery unit 200 shown in FIG. 7, for example, to construct a serially connected battery unit 200.

In addition, when constructing the aforementioned module 100 or battery unit 200, it may if necessary be further provided with a protective circuit (not shown) or PTC (not shown) similar to those provided for existing batteries.

The above explanation of the embodiment of an electrochemical device pertained to one having the construction of a secondary battery, but the electrochemical device of the invention may also be a primary battery, since it is sufficient if it has a construction which is provided with at least the anode, cathode and ion conductive electrolyte layer, wherein the anode and cathode are situated in an opposing manner through the electrolyte layer. In addition to the aforementioned examples of substances for the electrode active material of the composite particles P10, there may also be used those commonly used for existing primary batteries. The conductive additive and binder may be the same substances mentioned above.

The electrode of the invention is not restricted to a battery electrode, and for example, it may be an electrode used for an electrolytic cell, electrochemical capacitor (electric double layer capacitor, aluminum electrolyte condenser or the like), or an electrochemical sensor. The electrochemical device of the invention is also not restricted to being one for a battery, and for example, it may be an electrolytic cell, electrochemical capacitor (electric double layer capacitor, aluminum electrolyte condenser or the like), or an electrochemical sensor. For example, in the case of an electrode for an electric double layer capacitor, the electrode active material used in the composite particles P10 may be a carbon material with high electric bilayer capacity such as coconut shell active carbon, pitch-based active carbon or phenol resin-based active carbon.

The anode used for salt electrolysis may be, for example, thermally decomposed ruthenium oxide (or a complex oxide of ruthenium oxide and a different metal oxide) as the electrode active material of the invention, to be used as a structural material of the composite particles P10, and the active material-containing layer comprising the obtained composite particles P10 may be formed on a titanium base.

When the electrochemical device of the invention is an electrochemical capacitor, there are no particular restrictions on the electrolyte solution, and there may be used aqueous electrolyte solutions and non-aqueous electrolyte solutions (non-aqueous electrolyte solutions using organic solvents), which are commonly employed in electrochemical capacitors such as publicly known electric double layer capacitors.

Also, there are no particular restrictions on the type of non-aqueous electrolyte solution 30, but in most cases it will be selected in consideration of the solubility and dissociation degree of the solutes, as well as the solution viscosity, and it is preferably a non-aqueous electrolyte solution with high conductivity and a wide potential window. As organic solvents there may be mentioned propylene carbonate, diethylene carbonate, acetonitrile and the like. As examples of electrolytes there may be mentioned quaternary ammonium salts such as tetraethylammonium tetrafluoroborate. In this case, it will be necessary to strictly control the moisture inclusion.

### EXAMPLES

The present invention will now be explained in greater detail through the following examples and comparative examples, with the understanding that these examples are in no way limitative on the invention.

### (Example 1)

(1) Fabrication of Composite Particles

First, composite particles to be used for formation of the active material-containing layer of a lithium ion secondary battery cathode were fabricated by a method including the granulating step described above, according to the following procedure. The composite particles P10 were composed of the electrode active material of the cathode (92 wt %), a conductive additive (4.8 wt %) and a binder (3.2 wt %).

As the electrode active material of the cathode there were used particles of a complex metal oxide represented by the general formula: LiₓMn_{y}Ni_{z}Co_{1-x-y}O_{w} satisfying the conditions: x=1, x=0.33, z=0.33, w=2 (BET specific surface area: 0.55 m²/g, mean particle size: 12 μm). The conductive additive used was acetylene black. The binder used was polyvinylidene fluoride.

First, in the stock solution preparation step there was prepared a “stock solution” obtained by dispersing acetylene black in a solution prepared by dissolving polyvinylidene fluoride in N,N-dimethylformamide {(DMF): solvent} (3 wt % acetylene black, 2 wt % polyvinylidene fluoride).

Next, in the fluidized bed forming step, an air stream composed of air was generated in a container having the same construction as the fluidizing tank 5 shown in FIG. 3, and powder of the composite metal oxide was introduced to form a fluidized bed. Next, in the spray drying step, the stock solution was sprayed onto the fluidized powder of the composite metal oxide, to adhere the solution onto the powder surface. The temperature in the atmosphere in which the powder was placed during the spraying was kept constant in order to remove the N,N-dimethylformamide from the powder surface almost simultaneously with the spraying. The acetylene black and polyvinylidene fluoride were thus bonded to the powder surface to obtain composite particles P10 (mean particle size: 200 μm).

The respective amounts of the electrode active material, conductive additive and binder used for the granulating treatment were adjusted so that the weight ratios of the components in the finally obtained composite particles P10 were the values mentioned above.

(2) Fabrication of Electrode (Cathode)

The electrode (cathode) was fabricated by the dry process described above. First, a hot roll press machine having the same construction as shown in FIG. 4 was used, and the composite particles P10 (mean particle size: 200 μm) were introduced therein to form a sheet (10 cm width) comprising the active material-containing layer (dry sheet forming step). The heating temperature at this time was 120° C., and the pressurization was at a linear pressure of 500 kgf/cm. The sheet was then punched out to obtain a disk-shaped active material-containing layer (diameter: 15 mm).

Next, a hot melt conductive layer (thickness: 5 μm) was formed on one side of the disk-shaped current collector (aluminum foil, diameter: 15 mm, thickness: 20 μm). The hot melt conductive layer was a layer comprising the same conductive additive (acetylene black) used to fabricate the composite particles and the same binder (polyvinylidene fluoride) used to fabricate the composite particles (acetylene black: 20 wt %, polyvinylidene fluoride: 80 wt %).

Next, a sheet comprising the active material-containing layer produced earlier was situated on the hot melt conductive layer, and thermocompression bonded. The thermocompression bonding conditions were a thermocompression bonding time of 1 minute, a heating temperature of 180° C., and pressurization at 30 kgf/cm². This yielded an electrode (cathode) having an active material-containing layer thickness of 150 μm, an active material load of 45 mg/cm² and a porosity of 25 vol %.

### (Example 2)

(1) Fabrication of Composite Particles

First, composite particles to be used for formation of the active material-containing layer of a lithium ion secondary battery anode were fabricated by a method including a granulating step, according to the following procedure. The composite particles P10 were composed of the electrode active material of the anode (90 wt %), a conductive additive (5 wt %) and a binder (5 wt %).

As the electrode active material of the anode there were used artificial graphite particles as a fibrous graphite material (BET specific surface area: 1.0 m²/g, mean particle size: 19 μm). The conductive additive used was acetylene black. The binder used was polyvinylidene fluoride.

First, in the stock solution preparation step there was prepared a “stock solution” obtained by dispersing acetylene black in a solution prepared by dissolving polyvinylidene fluoride in N,N-dimethylformamide {(DMF): solvent} (3 wt % acetylene black, 2 wt % polyvinylidene fluoride).

Next, in the fluidized bed forming step, an air stream composed of air was generated in a container having the same construction as the fluidizing tank 5 shown in FIG. 3, and the artificial graphite powder was introduced to form a fluidized bed. Next, in the spray drying step, the stock solution was sprayed onto the fluidized artificial graphite powder, to adhere the solution onto the powder surface. The temperature in the atmosphere in which the powder was placed during the spraying was kept constant in order to remove the N,N-dimethylformamide from the powder surface almost simultaneously with the spraying. The acetylene black and polyvinylidene fluoride were thus bonded to the powder surface to obtain composite particles P10 (mean particle size: 200 μm).

The respective amounts of the electrode active material, conductive additive and binder used for the granulating treatment were adjusted so that the weight ratios of the components in the finally obtained composite particles P10 were the values mentioned above.

(2) Fabrication of Electrode (Anode)

The electrode (anode) was fabricated by the dry process described above. First, a hot roll press machine having the same construction as shown in FIG. 4 was used, and the composite particles P10 (mean particle size: 200 μm) were introduced therein to form a sheet (10 cm width) comprising the active material-containing layer (dry sheet forming step). The heating temperature at this time was 120° C., and the pressurization was at a linear pressure of 300 kgf/cm. The sheet was then punched out to obtain a disk-shaped active material-containing layer (diameter: 15 mm).

Next, a hot melt conductive layer (thickness: 5 μm) was formed on one side of the disk-shaped current collector (copper foil, diameter: 15 mm, thickness: 20 μm) . The hot melt conductive layer was a layer comprising the same conductive additive (acetylene black) used to fabricate the composite particles and a binder (polyethylene-methacrylic acid copolymer) (acetylene black: 30 wt %, polyethylene-methacrylic acid copolymer: 70 wt %).

Next, a sheet comprising the active material-containing layer produced earlier was situated on the hot melt conductive layer, and thermocompression bonded. The thermocompression bonding conditions were a thermocompression bonding time of 30 seconds, a heating temperature of 100° C., and pressurization at 10 kgf/cm². This yielded an electrode (anode) having an active material-containing layer thickness of 150 μm, an active material load of 22 mg/cm² and a porosity of 25 vol %.

### (Comparative Example 1)

An electrode (cathode) was fabricated by the conventional electrode fabricating procedure (wet process) described below. The electrode active material, conductive additive and binder used as the structural materials of the electrode were the same ones used in Example 1, and the electrode active material weight:conductive additive weight:binder weight was adjusted to be the same as in Example 1. The current collector used (provided with a hot melt layer) was also the same. as used in Example 1.

First, a binder solution was prepared by dissolving the binder in N-methylpyrrolidone (NMP) (binder concentration: 5 wt % based on total solution weight). Next, the electrode active material and conductive additive were introduced into the binder solution in the proportions mentioned above, and the mixture was mixed with a hypermixer to obtain a coating solution. The coating solution was coated onto the hot melt layer of the cathode current collector using a doctor blade. The liquid film composed of the coating solution formed on the cathode current collector was then dried.

Next, the cathode current collector with the liquid film in a dry state was subjected to rolling treatment using a roller press machine. The heating temperature for the treatment was 180° C., the heating time was 1 minute, and the pressurization was at 30 kgf/cm². This yielded an electrode (cathode) having an active material-containing layer thickness of 150 μm, an active material load of 45 mg/cm² and a porosity of 25 vol %.

### (Comparative Example 2)

An electrode (anode) was fabricated by the conventional electrode fabricating procedure (wet process) described below. The electrode active material, conductive additive and binder used as the structural materials of the electrode were the same ones used in Example 1, and the electrode active material weight:conductive additive weight:binder weight was adjusted to be the same as in Example 2. The current collector used (provided with a hot melt layer) was also the same as used in Example 2.

First, a binder solution was prepared by dissolving the binder in N-methylpyrrolidone (NMP) (binder concentration: 5 wt % based on total solution weight). Next, the electrode active material and conductive additive were introduced into the binder solution in the proportions mentioned above, and the mixture was mixed with a hypermixer to obtain a coating solution. The coating solution was coated onto the hot melt layer of the anode current collector using a doctor blade. The liquid film composed of the coating solution formed on the anode current collector was then dried.

Next, the anode current collector with the liquid film in a dry state was subjected to rolling treatment using a roller press machine. The heating temperature for the treatment was 100° C., the heating time was 30 seconds, and the pressurization was at 10 kgf/cm². This yielded an electrode (anode) having an active material-containing layer thickness of 150 μm, an active material load of 22 mg/cm² and a porosity of 25 vol %.

[Electrode characteristic evaluation test 1]

An electrochemical cell was fabricated using each of the electrodes of Examples 1 and 2 and Comparative Examples 1 and 2 as the “test electrode (working electrode)” and a lithium metal foil (diameter: 15 mm, thickness: 100 μm) as the counter electrode, and it was subjected to the characteristic evaluation test described below for evaluation of the electrode characteristics of each electrode (test electrode). The results of the evaluation test are shown in Table 1.

(1) Preparation of Electrolyte Solution

An electrolyte solution used to form the electrolyte layer was prepared by the following procedure. Specifically, LiClO₄ was dissolved in a solvent {ethylene carbonate (EC) and diethyl carbonate (DEC) mixed in a volume ratio of 1:1} to a volume molar concentration of 1 mol/L.

(2) Fabrication of Electrochemical Cell for Electrode Characteristic Evaluation Test

First, each test electrode was placed opposite the counter electrode, a polyethylene porous film separator (diameter: 21 mm, thickness: 30 μm) was situated between them, and a laminated body (element) was formed by laminating the anode, separator and cathode in that order. The leads (width: 10 mm, length: 25 mm, thickness: 0.50 mm) of the anode and cathode of the laminated body were connected by ultrasonic welding. The laminated body was placed in a sealed container serving as the frame for the electrochemical cell, and the prepared electrolyte solution was injected therein. A constant pressure was applied from both the anode and cathode of the laminated body. The electrochemical cell for each test electrode was fabricated in this manner.

(3) Electrode Characteristic Evaluation Test

When the test electrode was a cathode (the electrode of Example 1 and the electrode of Comparative Example 1), the potential of the test electrode was polarized in a potential range of +2.5 V to +4.3 V, based on the redox potential of the lithium metal of the counter electrode (constant current-constant voltage). The measurement evaluation test was carried out at 25° C.

When the test electrode was an anode (the electrode of Example 2 and the electrode of Comparative Example 2), the potential of the test electrode was polarized in a potential range of +0.01 V to +1.5 V, based on the redox potential of the lithium metal of the counter electrode (constant current-constant voltage). The measurement evaluation test was carried out at 25° C.

The electrical capacity (mAh.g⁻¹) per active material unit weight was determined for each electrode, when varying the discharge current density (mA.cm⁻²) The results are shown in Table 1.

TABLE 1

| | | Electrical capacity |
|---|---|---|
| | Discharge current | per active material |
| | density/ | unit weight/ |
| | mA · cm⁻² | mAh · g⁻¹ |
| Example 1 | 1.3 | 165 |
| Example 1 | 6.6 | 155 |
| Example 1 | 13.0 | 128 |
| Example 2 | 1.3 | 311 |
| Example 2 | 6.6 | 302 |
| Example 2 | 13.0 | 267 |
| Comparative | 1.3 | 125 |
| Example 1 | | |
| Comparative | 6.6 | 86 |
| Example 1 | | |
| Comparative | 13.0 | 33 |
| Example 1 | | |
| Comparative | 1.3 | 310 |
| Example 2 | | |
| Comparative | 6.6 | 241 |
| Example 2 | | |
| Comparative | 13.0 | 178 |
| Example 2 | | |

Based on the results shown in Table 1, the electrodes of Examples 1 and 2 were confirmed to have larger electrical capacities per active material unit weight and higher energy densities compared to the electrodes of Comparative Examples 1 and 2. These results suggested that in the active material-containing layers of the electrodes of Examples 1 and 2, the electrode active materials and conductive additives were non-isolated and electrically linked, and that satisfactory electron conduction networks and ion conduction networks had been formed.

### (Example 3)

First, one electrode (hereinafter referred to as “electrode C1”) having the same construction as the electrode (cathode) of Example 1 was fabricated by the same procedure and under the same conditions as in Example 1. Four electrodes (hereinafter referred to as “electrode C2”, “electrode C3”, “electrode C4” and “electrode C5”) having the same construction as the electrode (cathode) of Example 1, except that the same electrode active material-containing layer and hot melt conductive layer as the electrode of Example 1 were formed on both sides of the current collector, were fabricated by the same procedure and under the same conditions as in Example 1. The electrodes all had rectangular shapes with dimensions of 1.7 cm×3.1 cm.

Next, five electrodes (hereinafter referred to as “electrode A1”, “electrode A2”, “electrode A3”, “electrode A4” and “electrode A5”) having the same construction as the electrode (anode) of Example 2, except that the same electrode active material-containing layer and hot melt conductive layer as the electrode of Example 2 were formed on both sides of the current collector, were fabricated by the same procedure and under the same conditions as in Example 2. The electrodes all had rectangular shapes with dimensions of 1.8 cm×3.2 cm.

Nine separators made of polyethylene porous films (rectangular separators with a thickness of 30 μm and dimensions of 1.9 cm×3.3 cm) (hereinafter referred to as “separator S1” to “separator S9”) were prepared.

Next, a battery was constructed with a laminated body having the above-mentioned electrodes C1-C5, electrodes A1-A5 and separators S1-S9 laminated in the order: “C1/S1/A1/S2/C2/S3/A2/S4/C3/S5/A3/S6/C4/S7/A4/S8/C5/S9/A5” as the element. Each electrode was laminated in serial electrical connection. Electrodes C1-C5 were connected by ultrasonic welding using an aluminum foil (width: 10 mm, length: 25 mm, thickness: 0.50 mm) as the lead. Electrodes A1-A5 were connected by ultrasonic welding using a nickel foil (width: 10 mm, length: 25 mm, length: 0.50 mm) as the lead.

The element was placed in a cladding made of an aluminum laminate film together with an electrolyte solution to complete a film-like battery (2.0 cm×4.3 cm, thickness: 4.1 mm).

The electrolyte solution used was a solution prepared by dissolving LiPF₆ in a solvent {ethylene carbonate (EC) and diethyl carbonate (DEC) mixed in a volume ratio of 3:7} to a volume molar concentration of 1 mol/L.

### (Comparative Example 3)

First, one electrode (hereinafter referred to as “electrode C10”) having the same construction as the electrode (cathode) of Comparative Example 1 was fabricated by the same procedure and under the same conditions as in Comparative Example 1. Four electrodes (hereinafter referred to as “electrode C20”, “electrode C30”, “electrode C40” and “electrode C50”) having the same construction as the electrode (cathode) of Comparative Example 1, except that the same electrode active material-containing layer and hot melt conductive layer as the electrode of Comparative Example 1 were formed on both sides of the current collector, were fabricated by the same procedure and under the same conditions (wet process) as in Comparative Example 1. The electrodes all had rectangular shapes with dimensions of 1.7 cm×3.1 cm.

Next, four electrodes (hereinafter referred to as “electrode A10”, “electrode A20”, “electrode A30” and “electrode A40”) having the same construction as the electrode (anode) of Comparative Example 2, except that the same electrode active material-containing layer and hot melt conductive layer as the electrode of Comparative Example 2 were formed on both sides of the current collector, were fabricated by the same procedure and under the same conditions (wet process) as in Comparative Example 2. The electrodes all had rectangular shapes with dimensions of 1.8 cm×3.2 cm.

Nine separators made of polyethylene porous films (rectangular separators with a thickness of 30 μm and dimensions of 1.9 cm×3.3 cm) (hereinafter referred to as “separator S10” to “separator S90”) were prepared.

Next, a battery was constructed with a laminated body having the above-mentioned electrodes C10-C50, electrodes A10-A50 and separators S10-S90 laminated in the order: “C10/S10/A20/S20/C20/S30/A30/S40/C30/S50/A40/S60/C40/S 70/A50/S80/C50/S90/A10” as the element. Each electrode was laminated in serial electrical connection. Electrodes C10-C50 were connected by ultrasonic welding using an aluminum foil (width: 10 mm, length: 25 mm, thickness: 0.50 mm) as the lead. Electrodes A10-A50 were connected by ultrasonic welding using a nickel foil (width: 10 mm, length: 25 mm, length: 0.50 mm) as the lead.

The element was placed in a cladding made of an aluminum laminate film together with an electrolyte solution to complete a film-like battery (2.0 cm×4.3 cm, thickness: 4.1 mm).

The electrolyte solution used was a solution prepared by dissolving LiPF₆ in a solvent {ethylene carbonate (EC) and diethyl carbonate (DEC) mixed in a volume ratio of 3:7} to a volume molar concentration of 1 mol/L.

### (Comparative Example 4)

First, one electrode (hereinafter referred to as “electrode C100”) having the same construction as the electrode (cathode) of Comparative Example 1, except that the active material load of the active material-containing layer was 20 mg/cm² and the porosity was 33 vol %, was fabricated by the same procedure and under the same conditions (wet process) as in Comparative Example 1.

Also, seven electrodes (hereinafter referred to as “electrode C200”, “electrode C300”, “electrode C400”, “electrode C500”, “electrode C600”, “electrode C700” and “electrode C800”) having the same construction as the electrode (cathode) of Comparative Example 1, except that the active material load of the active material-containing layer was 20 mg/cm² and the porosity was 33 vol % and the same electrode active material-containing layer and hot melt conductive layer as the electrode of Comparative Example 1 were formed on both sides of the current collector, were fabricated by the same procedure and under the same conditions (wet process) as in Comparative Example 1. The electrodes all had rectangular shapes with dimensions of 1.7 cm×3.1 cm.

Also, eight electrodes (hereinafter referred to as “electrode A100”, “electrode A200”, “electrode A300”, “electrode A400”, “electrode A500”, “electrode A600”, “electrode A700” and “electrode A800”) having the same construction as the electrode (anode) of Comparative Example 2, except that the active material load of the active material-containing layer was 10 mg/cm² and the porosity was 35 vol % and the same electrode active material-containing layer and hot melt conductive layer as the electrode of Comparative Example 2 were formed on both sides of the current collector, were fabricated by the same procedure and under the same conditions (wet process) as in Comparative Example 2. The electrodes all had rectangular shapes with dimensions of 1.8 cm×3.2 cm.

Fourteen separators made of polyethylene porous films (rectangular separators with a thickness of 30 μm and dimensions of 1.9 cm×3.3 cm) (hereinafter referred to as “separator S100” to “separator S1400”) were prepared.

Next, a battery was constructed with a laminated body having the above-mentioned electrodes C100-C800, electrodes A100-A800 and separators S100-S1400 laminated in the order: “C100/S100/A200/S200/C200/S300/A300/S400/C300/S500/A40/S600/C400/S700/A500/S800/C500/S900/A600/S900/C600/S100/A700/S1100/C700/S1200/A800/S1300/C800/S1400/A100” as the element. Each electrode was laminated in serial electrical connection. Electrodes C100-C800 were connected by ultrasonic welding using an aluminum foil (width: 10 mm, length: 25 mm, thickness: 0.50 mm) as the lead. Electrodes A100-A800 were connected by ultrasonic welding using a nickel foil (width: 10 mm, length: 25 mm, length: 0.50 mm) as the lead.

The element was placed in a cladding made of an aluminum laminate film together with an electrolyte solution to complete a film-like battery (2.0 cm×4.3 cm, thickness: 4.0 mm).

The electrolyte solution used was a solution prepared by dissolving LiPF₆ in a solvent {ethylene carbonate (EC) and diethyl carbonate (DEC) mixed in a volume ratio of 3:7} to a volume molar concentration of 1 mol/L.

[Electrode Characteristic Evaluation Test 2]

The capacities and volume energy densities of the batteries of Example 3, Comparative Example 3 and Comparative Example 4 were measured with discharge currents of 70 mA, 175 mA and 350 mA. The results are shown in Tables 2 to 4.

TABLE 2

70 mA discharge

| | | Volume energy |
|---|---|---|
| | Capacity/ | density/ |
| | mAh | Wh · L⁻¹ |
| Example 3 | 369 | 394 |
| Comparative | 289 | 277 |
| Example 3 | | |
| Comparative | 266 | 282 |
| Example 4 | | |

TABLE 3

175 mA discharge

| | | Volume energy |
|---|---|---|
| | Capacity/ | density/ |
| | mAh | Wh · L⁻¹ |
| Example 3 | 369 | 371 |
| Comp. Ex. 3 | 214 | 200 |
| Comp. Ex. 4 | 248 | 259 |

TABLE 4

350 mA discharge

| | | Volume energy |
|---|---|---|
| | Capacity/ | density/ |
| | mAh | Wh · L⁻¹ |
| Example 3 | 311 | 300 |
| Comp. Ex. 3 | 96 | 87 |
| Comp. Ex. 4 | 236 | 247 |

### Example 4

(1) Fabrication of Composite Particles

Composite particles P10 (mean particle size: 150 μm) were obtained by the same procedure and under the same conditions as in Example 1, except that an activated, fibrous active carbon material (specific surface area: 2500 m²/g, aspect ratio: 1-1.5) serving as the electrode active material, a binder (fluorine-based resin, “Viton-GF”, trade name of DuPont) and a conductive additive (acetylene black, “DENKABLACK”, trade name of Denki Kagaku Kogyo) were used in a weight ratio of fibrous active carbon:binder:conductive additive=90:5:5.

(2) Fabrication of Electrodes

The electrode (cathode) was fabricated by the dry process described above. First, a hot roll press machine having the same construction as shown in FIG. 4 was used, and the composite particles P10 were introduced therein to form a sheet (width: 10 cm) comprising the active material-containing layer (dry sheet forming step). The heating temperature at this time was 120° C., and the pressurization was at a linear pressure of 300 kgf/cm. The sheet was then punched out to obtain a rectangular active material-containing layer (1.7 cm×3.1 cm).

Next, a hot melt conductive layer (thickness: 5 μm) was formed on one side of the rectangular current collector (aluminum foil, 1.7 cm×3.1 cm, thickness: 20 μm) . The hot melt conductive layer was a layer comprising the same conductive additive (acetylene black) used to fabricate the composite particles and the same fluorine-based resin used to fabricate the composite particles (acetylene black: 20 wt %, fluorine-based resin: 80 wt %).

Next, a sheet comprising the active material-containing layer produced earlier was situated on the hot melt conductive layer, and thermocompression bonded. The thermocompression bonding conditions were a thermocompression bonding time of 30 seconds, a heating temperature of 160° C., and pressurization at 10 kgf/cm². This yielded a polarized electrode having an active material-containing layer thickness of 130 μm, an active material load of 8.0 mg/cm² and a porosity of 65 vol %.

### Example 5

(1) Fabrication of Composite Particles

Composite particles P10 (mean particle size: 150 μm) were obtained by the same procedure and under the same conditions as in Example 1, except that the same structural materials were used as for the polarized electrode of Example 4, with the carbon material, binder and conductive additive in a weight ratio of carbon material:binder:conductive additive=88:6:6.

(2) Fabrication of Electrodes

The electrode (cathode) was fabricated by the dry process described above. First, a hot roll press machine having the same construction as shown in FIG. 4 was used, and the composite particles P10 (mean particle size: 150 μm) were introduced therein to form a sheet (width: 10 cm) comprising the active material-containing layer (dry sheet forming step). The heating temperature at this time was 120° C., and the pressurization was at a linear pressure of 300 kgf/cm. The sheet was then punched out to obtain a rectangular active material-containing layer (1.7 cm×3.1 cm).

Next, a hot melt conductive layer (thickness: 5 μm) was formed on one side of the rectangular current collector (aluminum foil, 1.7 cm×3.1 cm, thickness: 20 μm) . The hot melt conductive layer was a layer comprising the same conductive additive (acetylene black) used to fabricate the composite particles and the same fluorine-based resin used to fabricate the composite particles (acetylene black: 20 wt %, fluorine-based resin: 80 wt %).

Next, a sheet comprising the active material-containing layer produced earlier was situated on the hot melt conductive layer, and thermocompression bonded. The thermocompression bonding conditions were a thermocompression bonding time of 30 seconds, a heating temperature of 160° C., and pressurization at 10 kgf/cm². This yielded a polarized electrode having an active material-containing layer thickness of 130 μm, an active material load of 8.3 mg/cm² and a porosity of 65 vol %.

### Comparative Example 5

A polarized electrode having an active material-containing layer thickness of 145 μm, an active material load of 5.5 mg/cm² and a porosity of 75 vol % was obtained by the same procedure and under the same conditions as in Comparative Example 1, except that the same structural materials were used as for the polarized electrode of Example 4, methyl isobutyl ketone was used as the solvent, and the shape of the electrode was rectangular (1.7 cm'3.1 cm).

### (Comparative Example 6)

(1) Fabrication of Composite Particles

Composite particles P10 (mean particle size: 150 μm) were obtained by the same procedure and under the same conditions as in Example 1, except that the same structural materials were used as for the polarized electrode of Example 4, with the carbon material, binder and conductive additive in a weight ratio of carbon material:binder:conductive additive=86:7:7.

(2) Fabrication of Electrodes

The electrode (cathode) was fabricated by the dry process described above. First, a hot roll press machine having the same construction as shown in FIG. 4 was used, and the composite particles P10 were introduced therein to form a sheet (width: 10 cm) comprising the active material-containing layer (dry sheet forming step). The heating temperature at this time was 120° C., and the pressurization was at a linear pressure of 300 kgf/cm. The sheet was then punched out to obtain a rectangular active material-containing layer (1.7 cm×3.1 cm).

Next, a hot melt conductive layer (thickness: 5 μm) was formed on one side of the rectangular current collector (aluminum foil, 1.7 cm×3.1 cm, thickness: 20 μm). The hot melt conductive layer was a layer comprising the same conductive additive (acetylene black) used to fabricate the composite particles and the same fluorine-based resin used to fabricate the composite particles (acetylene black: 20 wt %, fluorine-based resin: 80 wt %).

Next, a sheet comprising the active material-containing layer produced earlier was situated on the hot melt conductive layer, and thermocompression bonded. The thermocompression bonding conditions were a thermocompression bonding time of 30 seconds, a heating temperature of 160° C., and pressurization at 10 kgf/cm². This yielded a polarized electrode having an active material-containing layer thickness of 140 μm, an active material load of 7.8 mg/cm² and a porosity of 70 vol %.

[Electrode characteristic evaluation test 3]

The electrodes of Examples 4 and 5 and Comparative Examples 5 and 7 were subjected to the following electrode characteristic evaluation test. First, two electrodes were formed and laminated in an opposing manner through a porous cellulose separator.

Next, an electrolyte solution {a solution of triethylmethylammonium tetrafluoroborate (TEMA⁺.BF₄⁻) in propylene carbonate at a concentration of 1.2 mol/L} was injected into the laminated body to fabricate a cell element. A current of 2 mA/F was passed through the cell element, and the static capacity and volume energy density were calculated as an electrical double layer capacitor. The results are shown in Table 5.

TABLE 5

| | | Volume energy |
|---|---|---|
| | | density/ |
| | Static capacity/F | Wh · L⁻¹ |
| Example 4 | 2.6 | 3.2 |
| Example 5 | 2.5 | 3.1 |
| Comparative | 1.7 | 1.8 |
| Example 5 | | |
| Comparative | 2.0 | 2.3 |
| Example 6 | | |

As these results show, the electrodes of Examples 4 and 5, and the electric double layer capacitors constructed with the electrodes of Examples 4 and 5, were confirmed to have higher static capacities and higher energy densities than the electrodes of Comparative Examples 5 and 6 and the electric double layer capacitors constructed with the electrodes of Comparative Examples 5 and 6.

[Observation of Active Material-Containing Layer Cross-Section]

SEM and TEM photographs were taken of the cross-sections of the active material-containing layers of the electrodes of Example 4, Comparative Example 5 and Comparative Example 6 by the procedure described below, and the internal structures of the respective active material-containing layers were observed.

Portions of the electrodes of Example 4 and Comparative Example 5 were obtained by punching out rectangular (5 mm×5 mm) strips. The active material-containing layer of each strip of the electrodes of Example 4 and Comparative Example 5 was filled with resin (epoxy), and the active material-containing layer was surface-polished. Each of the strips of the electrodes of Example 4 and Comparative Example 5 was sliced with a microtome to obtain measuring samples for SEM and TEM photography (0.1 mm×0.1 mm). Each of the measuring samples was then photographed by SEM and TEM.

A portion of the electrode of Comparative Example 6 was obtained by punching out a rectangular (5 mm×5 mm) strip. The active material-containing layer of the strip of the electrode of Comparative Example 6 was filled with resin (epoxy), and the active material-containing layer was surface-polished. The strip of the electrode of Comparative Example 6 was then sliced with a microtome to obtain measuring samples for SEM and TEM photography (0.1 mm×0.1 mm). Each of the measuring samples was then photographed by SEM.

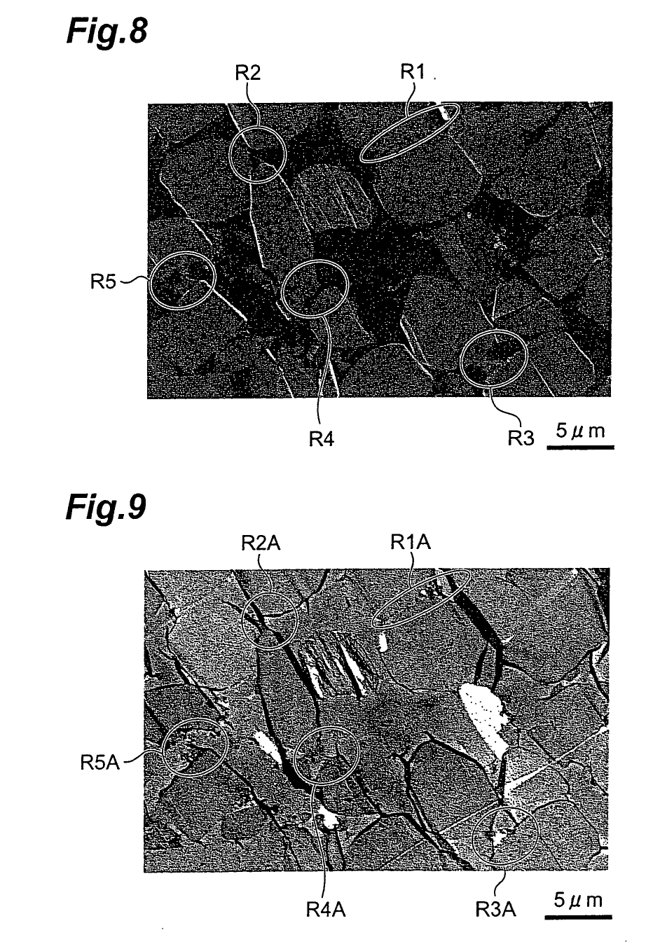

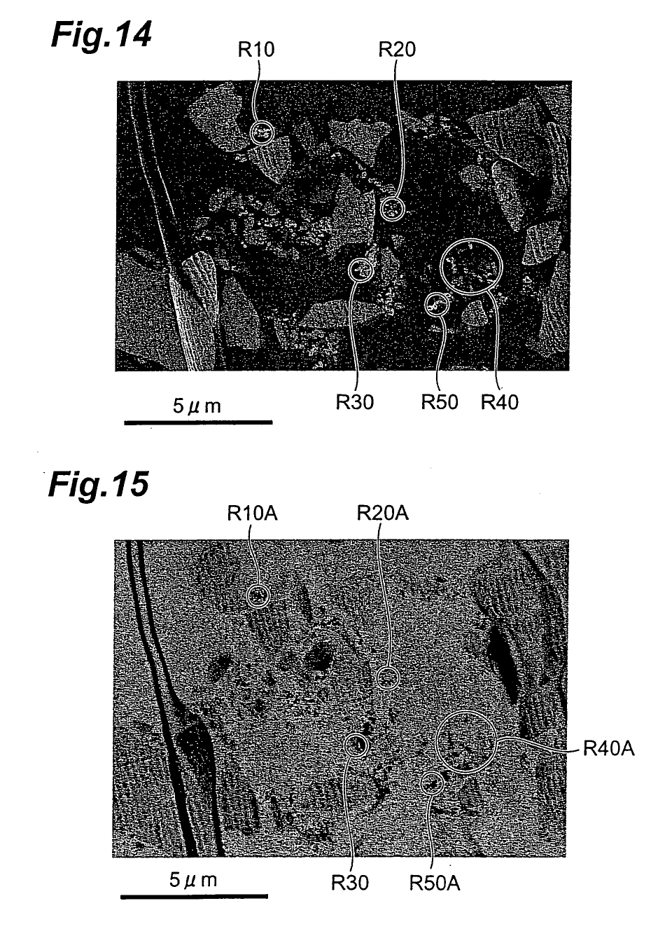

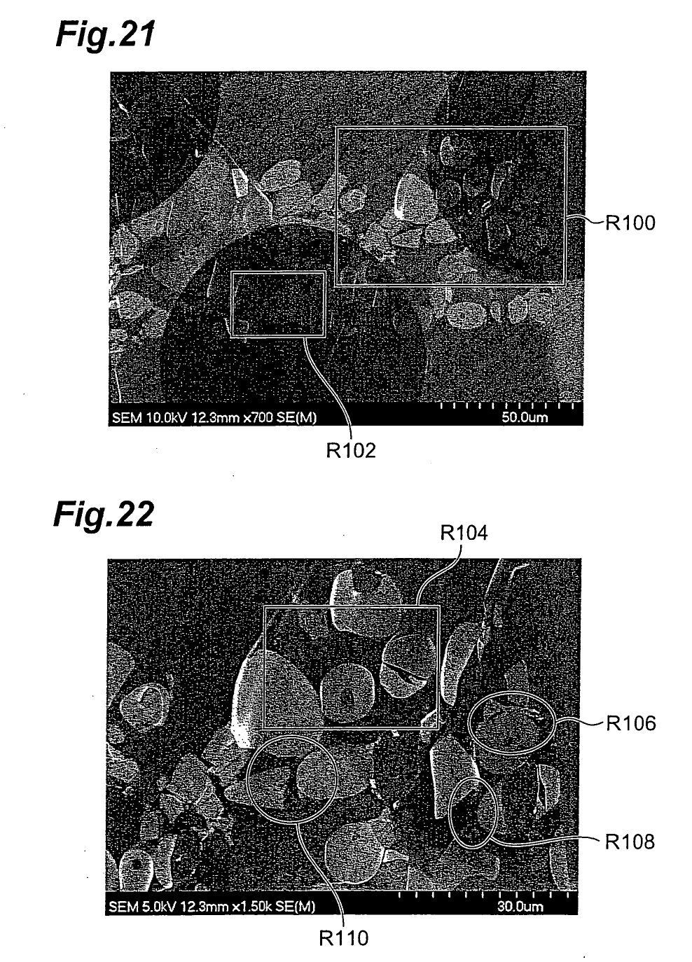

The results of SEM and TEM photography of the active material-containing layer of the electrode of Example 4 are shown in FIG. 8 to FIG. 13. The results of SEM and TEM photography of the active material-containing layer of the electrode of Comparative Example 5 are shown in FIG. 14 to FIG. 19. The results of SEM photography of the active material-containing layer of the electrode of Comparative Example 6 are shown in FIG. 21 to FIG. 26.

FIG. 8 is an SEM photograph taken of a cross-section of the active material-containing layer of an electrode (electric double layer capacitor) produced by the manufacturing process (dry process) of the invention. FIG. 9 is a TEM photograph taken of a cross-section (the same portion as shown in FIG. 8) of the active material-containing layer of an electrode (electric double layer capacitor) produced by the manufacturing process (dry process) of the invention.

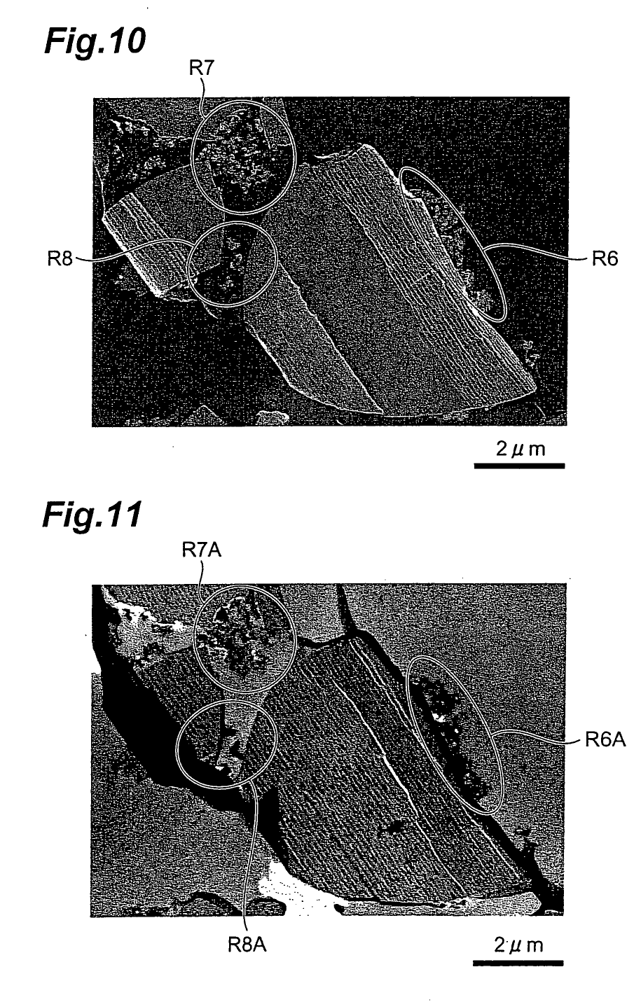

FIG. 10 is an SEM photograph taken of a cross-section of the active material-containing layer of an electrode (electric double layer capacitor) produced by the manufacturing process (dry process) of the invention. FIG. 11 is a TEM photograph taken of a cross-section (the same portion as shown in FIG. 10) of the active material-containing layer of an electrode (electric double layer capacitor) produced by the manufacturing process (dry process) of the invention.

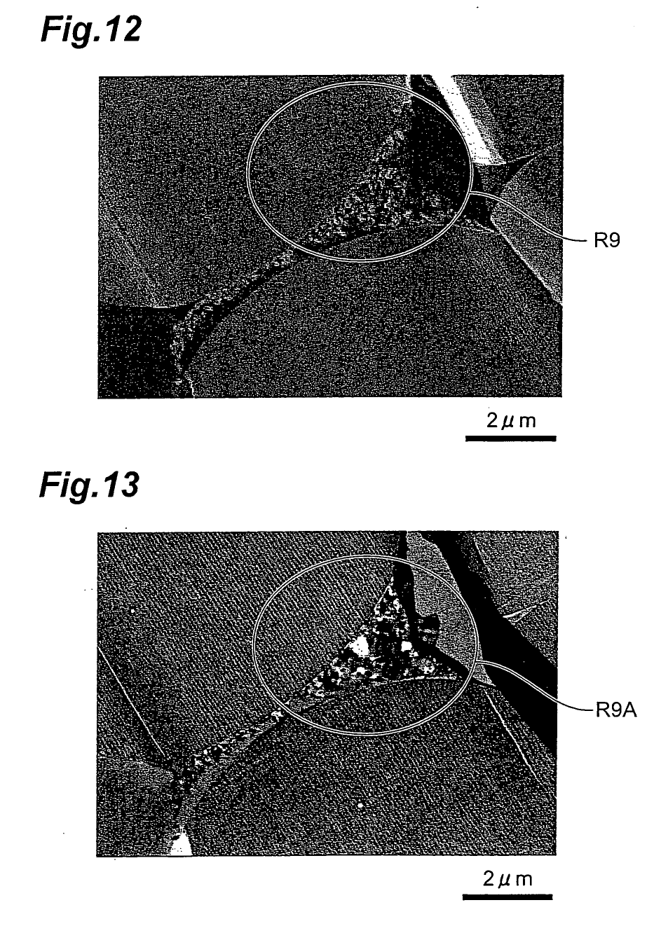

FIG. 12 is an SEM photograph taken of a cross-section of the active material-containing layer of an electrode (electric double layer capacitor) produced by the manufacturing process (dry process) of the invention. FIG. 13 is a TEM photograph taken of a cross-section (the same portion as shown in FIG. 12) of the active material-containing layer of an electrode (electric double layer capacitor) produced by the manufacturing process (dry process) of the invention.

FIG. 14 is an SEM photograph taken of a cross-section of the active material-containing layer of an electrode (electric double layer capacitor) produced by a manufacturing process (wet process) of the prior art. FIG. 15 is a TEM photograph taken of a cross-section (the same portion as shown in FIG. 14) of the active material-containing layer of an electrode (electric double layer capacitor) produced by a manufacturing process (wet process) of the prior art.

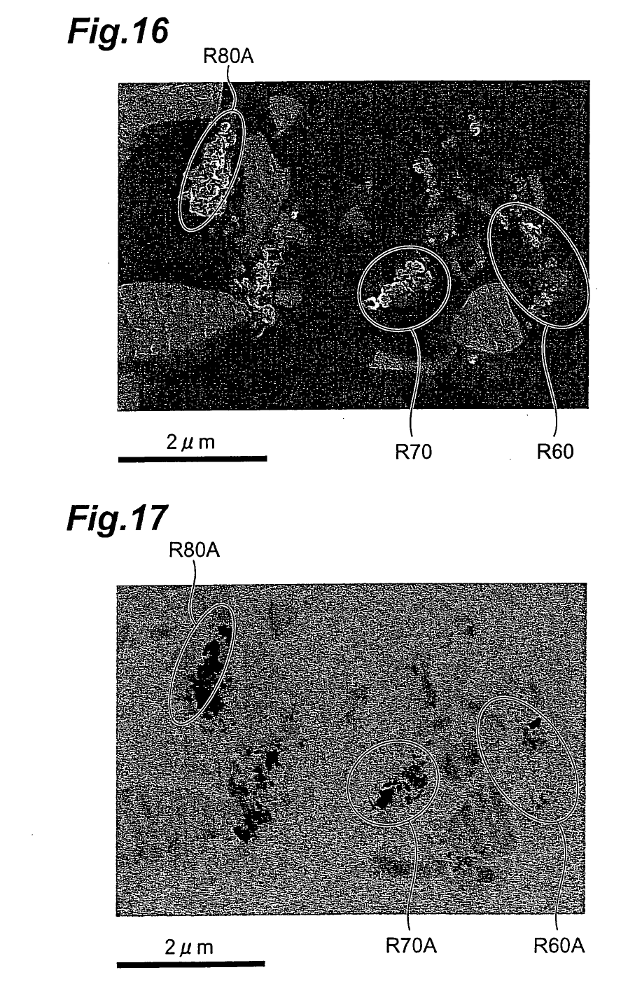

FIG. 16 is an SEM photograph taken of a cross-section of the active material-containing layer of an electrode (electric double layer capacitor) produced by a manufacturing process (wet process) of the prior art. FIG. 17 is a TEM photograph taken of a cross-section (the same portion as shown in FIG. 16) of the active material-containing layer of an electrode (electric double layer capacitor) produced by a manufacturing process (wet process) of the prior art.

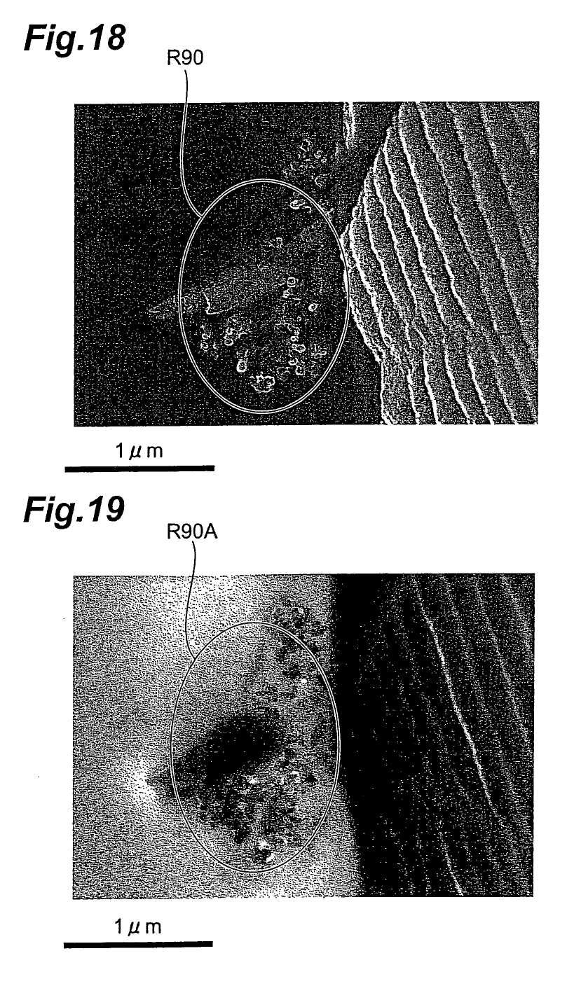

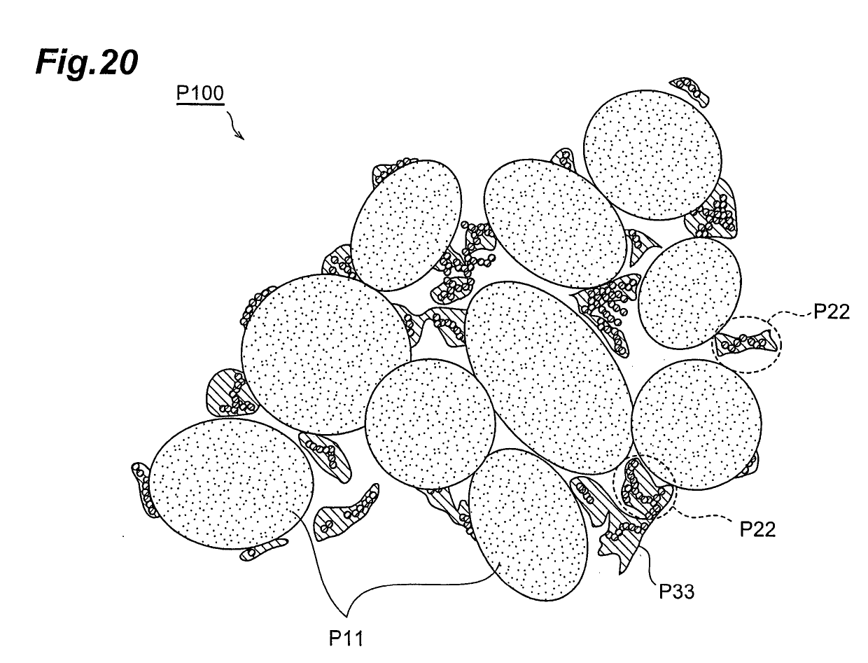

FIG. 18 is an SEM photograph taken of a cross-section of the active material-containing layer of an electrode (electric double layer capacitor) produced by a manufacturing process (wet process) of the prior art. FIG. 19 is a TEM photograph taken of a cross-section (the same portion as shown in FIG. 18) of the active material-containing layer of an electrode (electric double layer capacitor) produced by a manufacturing process (wet process) of the prior art.

As is clear from the results shown in FIG. 8 to FIG. 12, the electrode of Example 4 was confirmed to have the following structure. Specifically, based on observation of, for example, the photograph regions R1-R5 in FIG. 8 and the photograph regions R1A-R5A in FIG. 9 (corresponding respectively to R1-R5 in FIG. 8), it was confirmed that the aggregates composed of the conductive additive and binder electrically and physically bond together the contiguous active carbon particles, thereby forming a satisfactory electron conduction network and ion conduction network.

The internal structure of the active material-containing layer was more clearly confirmed from observation of the enlarged photographs, i.e. the photograph regions R6-R8 in FIG. 10 and the photograph regions R6A-R8A in FIG. 11 (corresponding respectively to R6-R8 in FIG. 10), and from observation of the photograph region R9 in FIG. 12 and the photograph region F9A in FIG. 13 (corresponding to R9 in FIG. 12).

On the other hand, as clearly shown by the results shown in FIG. 14 and FIG. 15, it was confirmed that the electrode of Comparative Example 5 had the following structure. Specifically, based on observation of, for example, the photograph regions R10-R50 in FIG. 14 and the photograph regions R10A-R50A in FIG. 15 (corresponding respectively to R10-R50 in FIG. 14), it was clearly observed that the aggregates composed of the conductive additive and binder were electrically and physically isolated from the active carbon particles, and it was confirmed that a satisfactory electron conduction network and ion conduction network had not been formed, in comparison to the active material-containing layer of Example 4.

The internal structure of the active material-containing layer was more clearly confirmed from observation of the enlarged photographs, i.e. the photograph regions R60-R80 in FIG. 16 and the photograph regions R60A-R80A in FIG. 17 (corresponding respectively to R60-R80 in FIG. 16), and from observation of the photograph region R90 in FIG. 18 and the photograph region R90A in FIG. 19 (corresponding to R90 in FIG. 18).

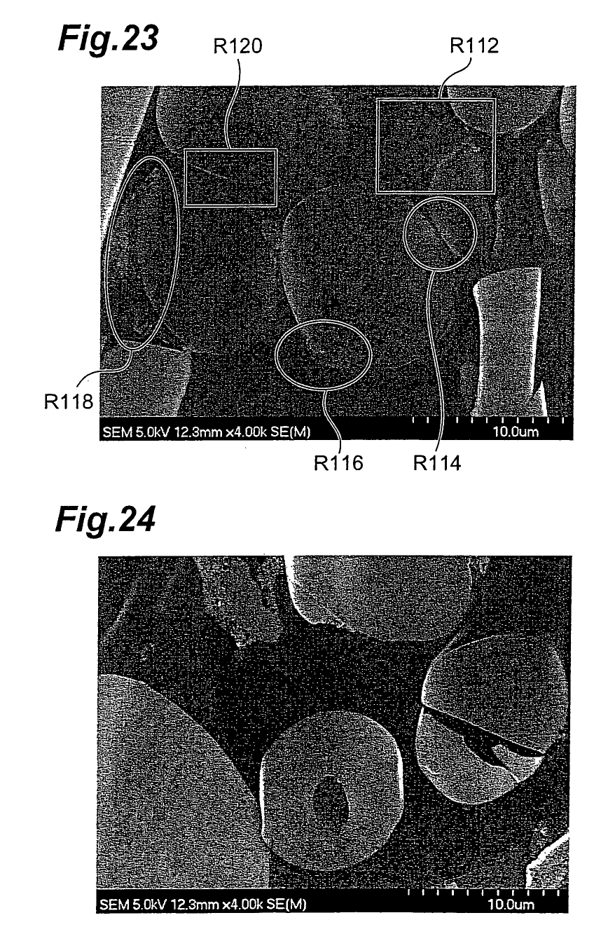

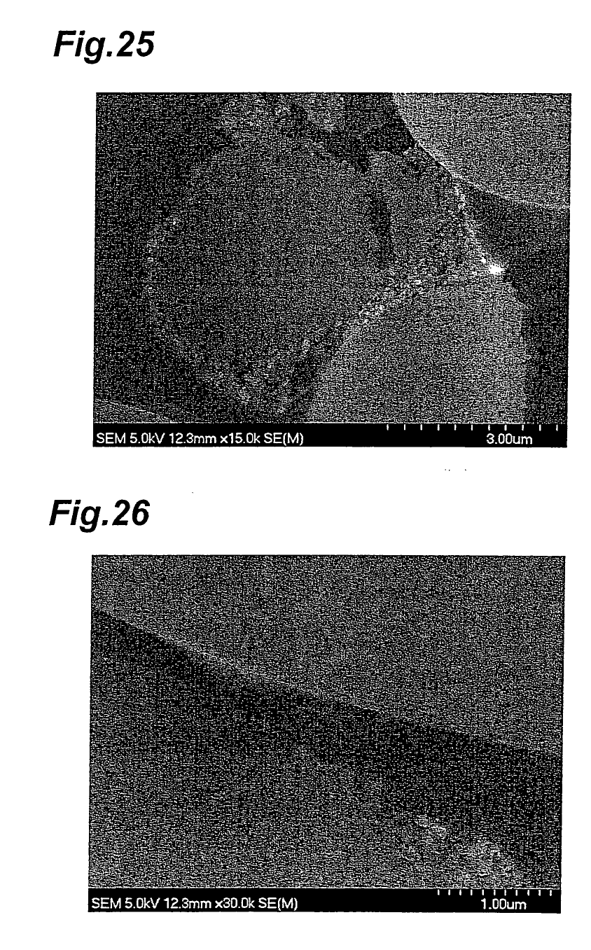

FIG. 21 is an SEM photograph taken of a cross-section of the active material-containing layer of an electrode (electric double layer capacitor) produced by a manufacturing process (wet process) of the prior art. FIG. 22 is an enlargement of the photograph region R100 shown in FIG. 21. FIG. 23 is an enlargement of the photograph region R102 shown in FIG. 21. FIG. 24 is an enlargement of the photograph region R104 shown in FIG. 22. FIG. 25 is an enlargement of the photograph region R112 shown in FIG. 23. FIG. 26 is an enlargement of the photograph region R120 shown in FIG. 23.

As shown by the photograph region R110 in FIG. 22, the photograph region R114 in FIG. 23, FIG. 24 (the photograph region R104 in FIG. 22) and FIG. 26 (the photograph region R120 in FIG. 23), it was confirmed that a great number of sections with no conductive additive or binder were present in the surfaces of the particles made of the electrode active materials in the active material-containing layers of the electrodes fabricated by the wet process. Also, as shown by the photograph regions R106 and R108 in FIG. 22, the photograph region R118 in FIG. 23, and FIG. 25 (the photograph region R112 in FIG. 23), it was confirmed that a great number of large masses composed of aggregates of the conductive additive and huge masses composed of aggregates of the binder were present in the active material-containing layers of the electrodes fabricated by the wet process.

In addition, as shown by the photographed regions such as R116 in FIG. 23, it was confirmed that a great number of sections wherein the conductive additive and binder were not bonded but isolated on the surfaces of the particles made of the electrode active materials in the active material-containing layers of the electrodes fabricated by the wet process. Also, since the compression distribution of the constituent particles was notable and many gaps were present in the active material-containing layer of the electrode, it was confirmed that diffusion of the constituent particles in the layer was non-uniform, and that the state of bonding between the constituent particles was inadequate. This confirmed that a sufficient electron conduction network and ion conduction network had not been formed in the active material-containing layer of the electrode.

1. An electrode having at least a conductive active material-containing layer comprising, as the structural material, composite particles composed of an electrode active material, a conductive additive with an electron conductive property, and a binder capable of binding the electrode active material and the conductive additive, and a current collector situated in electrical contact said the active material-containing layer,
wherein said composite particles are formed by a granulating step in which said conductive additive and said binder are bonded to and integrated with the particles made of said electrode active material,
said active material-containing layer is formed by a dry sheet-forming step wherein the powder comprising at least said composite particles obtained by said granulating step is subjected to pressurization treatment to form a sheet in order to obtain a sheet containing at least said composite particles, and an active material-containing layer placement step wherein said sheet is placed as said active material-containing layer at a position on said current collector where said active material-containing layer is to be formed,
and said electrode active material and said conductive additive are non-isolated and electrically linked in said active material-containing layer.

2. An electrode according to claim 1, wherein said active material-containing layer is obtained by further carrying out heat treatment during the pressurization treatment in said dry sheet-forming step.

3. An electrode according to claim 1, wherein said composite particles are formed by said granulating step which comprises
a stock solution preparation step wherein a stock solution containing said binder, said conductive additive and solvent is prepared,
a fluidized bed forming step wherein the particles made of said electrode active material are introduced into a fluidizing tank to form a fluidized bed of the particles made of said electrode active material, and
a spray drying step wherein said stock solution is sprayed in said fluidized bed containing the particles made of said electrode active material to attach and dry said stock solution onto the particles made of said electrode active material, said solvent is removed from said stock solution attached to the surfaces of the particles made of said electrode active material, and the particles made of said electrode active material are bonded to the particles made of said conductive additive by said binder.

4. An electrode according to claim 1, wherein said composite particles are formed by said granulating step which comprises
a stock solution preparation step wherein a stock solution containing said binder, said conductive additive and solvent is prepared,
a fluidized bed forming step wherein an air stream is generated in a fluidizing tank and particles made of said electrode active material are introduced into said air stream to form a fluidized bed of the particles made of said electrode active material, and
a spray drying step wherein said stock solution is sprayed in said fluidized bed containing the particles made of said electrode active material to attach and dry said stock solution onto the particles made of said electrode active material, said solvent is removed from said stock solution attached to the surfaces of the particles made of said electrode active material, and the particles made of said electrode active material are bonded to the particles made of said conductive additive by said binder.

5. An electrode according to claim 1, wherein said powder used for said dry sheet-forming step is powder composed solely of the composite particles.

6. An electrode according to claim 1, wherein said powder used in said dry sheet-forming step further contains at least one selected from among said conductive additive and said binder.

7. An electrode according to claim 1, wherein the thickness T of said active material-containing layer satisfies the condition represented by the following inequality (1)
100 μm≦T≦2000 μm (1)

8. An electrode according to claim 1, wherein the mean particle size d of said composite particles in said active material-containing layer satisfies the condition represented by the following inequality (2).
10 μm≦d≦2000 μm (2)

9. An electrode according to claim 1, wherein the thickness T of said active material-containing layer and the mean particle size d of said composite particles in said active material-containing layer satisfy the condition represented by the following inequality (3).
1/20≦T/d≦200 (3)

10. An electrode according to claim 1, wherein the content of said conductive additive in said active material-containing layer is 0.5-6 wt % based on the total weight of said active material-containing layer,
the content of said binder in said active material-containing layer is 0.5-6 wt % based on the total weight of said active material-containing layer, and
the thickness T of said active material-containing layer satisfies the condition represented by the following inequality (4).
120 μm≦T≦2000 μm (4)

11. An electrochemical device comprising an anode and cathode situated in a mutually opposing manner, and an electrolyte layer having ion conductivity situated between said anode and said cathode,
wherein either or both said anode or said cathode has at least a conductive active material-containing layer comprising, as the structural material, composite particles composed of an electrode active material, a conductive additive with an electron conductive property, and a binder capable of binding said electrode active material and said conductive additive, and a current collector situated in electrical contact with said active material-containing layer,
said composite particles are formed by a granulating step in which said conductive additive and said binder are bonded to and integrated with particles made of said electrode active material,
said active material-containing layer is formed by a dry sheet-forming step wherein the powder comprising at least said composite particles obtained by said granulating step is subjected to pressurization treatment to form a sheet in order to obtain a sheet containing at least said composite particles, and an active material-containing layer placement step wherein said sheet is placed as said active material-containing layer at a position on said current collector where said active material-containing layer is to be formed, and
said electrode active material and said conductive additive are non-isolated and electrically linked in said active material-containing layer.

12. A method for manufacturing an electrode having at least a conductive active material-containing layer comprising an electrode active material, and a current collector situated in electrical contact with said active material-containing layer,
the method for manufacturing an electrode comprising
a granulating step in which a conductive additive and a binder capable of binding said electrode active material and said conductive additive are bonded to and integrated with particles made of said electrode active material to form composite particles comprising said electrode active material, said conductive additive and said binder,
a dry sheet-forming-forming step in which powder comprising at least said composite particles obtained by said granulating step is subjected to pressurization treatment to form a sheet in order to obtain a sheet containing at least said composite particles, and
an active material-containing layer placement step in which said sheet is placed at the location of said current collector at which said active material-containing layer is to be formed, as said active material-containing layer,
wherein said granulating step comprises
a stock solution preparation step wherein a stock solution containing said binder, said conductive additive and a solvent is prepared,
a fluidized bed forming step wherein the particles made of said electrode active material are introduced into a fluidizing tank to form a fluidized bed of the particles made of said electrode active material, and
a spray drying step wherein said stock solution is sprayed in said fluidized bed containing the particles made of said electrode active material to attach and dry said stock solution onto the particles made of said electrode active material, said solvent is removed from said stock solution attached to the surfaces of the particles made of said electrode active material, and the particles made of said electrode active material are bonded to the particles made of said conductive additive by said binder.

13. A method for manufacturing an electrode according to claim 12 wherein, in said dry sheet-forming step, heat treatment is further carried out during the pressurization treatment of said powder.

14. A method for manufacturing an electrode according to claim 12, wherein air stream is generated in said fluidizing tank during said fluidizing bed forming step and the particles made of said electrode active material are introduced into said air stream to form a fluidized bed of the particles made of said electrode active material.

15. A method for manufacturing an electrode according to claim 12, wherein said powder used in said dry sheet-forming step is a powder composed solely of said composite particles.

16. A method for manufacturing an electrode according to claim 12, wherein said powder used in said dry sheet-forming step is powder further containing at least one selected from among said conductive additive and said binder.

17. A method for manufacturing an electrode according to claim 12, wherein the thickness T of said active material-containing layer satisfies the condition represented by the following inequality (1).
100 μm≦T≦2000 μm (1)

18. A method for manufacturing an electrode according to claim 12, wherein the mean particle size d of said composite particles in said active material-containing layer satisfies the condition represented by the following inequality (2).
10 μm≦d≦2000 μm (2)

19. A method for manufacturing an electrode according to claim 12, wherein the thickness T of said active material-containing layer and the mean particle size d of said composite particles in said active material-containing layer satisfy the condition represented by the following inequality (3).
1/20≦T/d≦200 (3)

20. A method for manufacturing an electrode according to claim 12, wherein the content of said conductive additive in said active material-containing layer is 0.5-6 wt % based on the total weight of said active material-containing layer,
the content of said binder in said active material-containing layer is 0.5-6 wt % based on the total weight of said active material-containing layer, and
the thickness T of said active material-containing layer satisfies the condition represented by the following inequality (4).
120 μm≦T≦2000 μm (4)

21. A method for manufacturing an electrode according to claim 12 wherein, in said granulating step, the temperature in aid fluidizing tank is adjusted to above 50° C. and no higher than the melting point of said binder.

22. A method for manufacturing an electrode according to claim 12 wherein, in said granulating step, an air stream composed of one gas selected from among air, nitrogen gas and inert gases is generated in said fluidizing tank.

23. A method for manufacturing an electrochemical device provided with an anode and cathode situated in a mutually opposing manner, and an electrolyte layer having ion conductivity situated between said anode and said cathode,
the method for manufacturing an electrochemical device employing an electrode wherein either or both said anode or said cathode has
at least a conductive active material-containing layer comprising, as the structural material, composite particles composed of an electrode active material, a conductive additive with an electron conductive property, and a binder capable of binding said electrode active material and said conductive additive, and a current collector situated in electrical contact with said active material-containing layer,
said composite particles are formed by a granulating step in which said conductive additive and said binder are bonded to and integrated with particles made of said electrode active material,
said active material-containing layer is formed by a dry sheet-forming step wherein powder comprising at least said composite particles obtained by said granulating step is subjected to pressurization treatment to form a sheet in order to obtain a sheet containing at least said composite particles, and an active material-containing layer placement step wherein said sheet is placed as said active material-containing layer at a position on said current collector where said active material-containing layer is to be formed, and
said electrode active material and said conductive additive are non-isolated and electrically linked in said active material-containing layer.
